(19) United States
(12) Patent Application Publication
(10) Pub. No.: US 2009/0204588 A1
(43) Pub. Date: Aug. 13, 2009

(54) METHOD AND APPARATUS FOR DETERMINING KEY ATTRIBUTE ITEMS

(75) Inventors: Yuichi Hosono, Kawasaki (JP); Taiji Okamoto, Kawasaki (JP); Masashi Oguchi, Kawasaki (JP); Masanori Kishine, Hiroshima (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/367,057

(22) Filed: Feb. 6, 2009

(30) Foreign Application Priority Data
Feb. 8, 2008 (JP) 2008-028348

(51) Int. Cl. G06F 17/30

(52) U.S. Cl. 707/3; 707/E17.108

(57) ABSTRACT

A computer program, method, and apparatus for determining key attribute items and search keywords for use in analysis of incident records. Master tables provide a collection of registered text strings which may appear in incident records. Upon entry of a specified keyword, a master table search processor searches the master tables to extract a master table containing the specified keyword, as well as identifying under which attribute item of the extracted master table the specified keyword is found. The identified attribute item is referred to as a key attribute item. Then out of the extracted master table, a search keyword extractor extracts every text string under the key attribute item for use as search keywords. With those search keywords, an attribute item information generator retrieves incident records and produces attribute item information from the retrieved incident records and the key attribute item.

### CROSS-REFERENCE TO RELATED APPLICATIONS

This application is based upon and claims the benefits of priority from the prior Japanese Patent Application No. 2008-028348, filed on Feb. 8, 2009, the entire contents of which are incorporated herein by reference.

### BACKGROUND OF THE INVENTION

1. Field of the Invention

The present invention relates to a computer program and method for determining attribute items for incident analysis, as well as to a data analyzing apparatus having such capabilities. More particularly, the present invention relates to a computer program and method, as well as a data analyzing apparatus implementing the same, for determining key attribute items for use in analysis of incident records stored in a database.

2. Description of the Related Art

There is a class of data analysis systems that collect records of events in a text database and perform statistical analysis on the stored data for the purpose of studying the statistics of particular events or seeking prevention of undesired events. Such a data analysis system is used, for example, with an incident database storing problem logs, including their symptoms observed, causes found, and actions taken. The system analyzes such incident records to identify the tendency of past incidents.

The above data analysis system has to be able to extract incident records containing required information out of a vast amount of stored data, so that a collection of qualified incident records will be subjected to data analysis. To this end, the incident record database includes not only data items describing incidents, but also additional information such as classification code and keywords related to the data items constituting each incident record. The items of such additional information are defined previously, depending on what kind of events will be recorded in an incident log and in what locations or machines such events would happen.

When starting data analysis, the user specifies which attribute item to analyze, by picking up a data item having a particular significance to him/her. The system then extracts incident records under that specified attribute item and subjects them to data analysis. Incident records include classification code and other various data fields, which can be specified as a key attribute item for selecting a subset of those incident records for analysis purposes.

Another method of determining a key attribute item is to extract a word or phrase (combination of words) from the actual text of data records. This alternative method eliminates the need for previously defining additional information describing the records. Instead, the method defines a key attribute item by extracting a word or phrase from incident records themselves in accordance with the user's interest. The incident records containing the specified word or phrase will then be extracted and subjected to data analysis.

Those who enter incident records to a database have their own policies for selection of classification codes. The difference of selection policies results in similar incident records having different classification codes. This could reduce the hit rate in a record search, thus bringing unsatisfactory search results to end users. To solve such problems related to the lack of organized data item definitions, there is proposed a document management system that previously defines some models of incidents and provides a system of classification codes and other items for each predefined model. See, for example, Japanese Patent Application Publication No. 2003-316787.

The above-described conventional data analysis systems, however, lack the ability to determine key attribute items in a flexible way according to changes of user demand or operating environment for the reasons described below. Conventionally the operator of a data analysis system has to define classification codes and other attributes (collectively referred to as metadata) of incident records, taking into consideration how they will be used later in a data mining process. Besides the difficulty of providing complete and exhaustive definitions beforehand, the operating environment of the system may change, necessitating different metadata. The operator has therefore to devote more time to add new definitions or modify the existing definitions. Some type of change even requires retroactive updating of past records stored in the database.

As can be seen from the above, conventional data analysis systems impose a burden on the operator to modify metadata of incident records to deal with a change in the user demand or operating environment. Operating cost of such a system tends to increase due to the extra time spent in registering definitions and additional memory space for storing metadata. The data analysis system performs data analysis on a set of incident records extracted on the basis of key attribute items that the user has specified. The user has therefore to define new key attribute items when he/she wishes to shift the focus of analysis.

The foregoing alternative method allows the user to extract a word or phrase from actual text data records for use as a key attribute item at the time of, or prior to, the analysis. While this method is advantageous in its flexibility of attribute item selection, the incident records extracted for analysis are limited by the user's choice of key attribute items. For expanded coverage of analysis, more words and phrases should be defined as additional attribute items, such that more related records can be extracted. It is, however, not easy to define such a complete set of key attribute items beforehand. Some incident records are unavoidably neglected even though they are related to the subject of analysis. In addition, a new set of key attribute items has to be defined when there is a change in the user's need or operating environment.

### SUMMARY OF THE INVENTION

In view of the foregoing, it is an object of the present invention to provide a computer program for dynamically determining key attribute items for data analysis according to user demand and operating environment. It is another object of the present invention to provide a method for the same. It is yet another object of the present invention to provide a data analyzing apparatus having such capabilities.

To accomplish the first object stated above, the present invention provides a computer-readable storage medium encoded with a program for determining key attribute items for analysis of document records. When executed on a computer, this program causes the computer to act as an apparatus comprising: (a) a master table search processor that extracts a master table containing a text string that matches with a specified keyword and identifies an attribute item of the master table under which the match is found; (b) a search keyword extractor that extracts text strings registered under the identified attribute item of the extracted master table for use as search keywords, while selecting the identified attribute item as a key attribute item; (c) an attribute item information generator that searches stored document records to extract those containing the search keywords and produces attribute item information associating each of the extracted document records with the search keywords found therein and key attribute items corresponding thereto; and (d) an attribute item information storage unit that stores the produced attribute item information.

Further, to accomplish the second object stated above, the present invention provides a method for determining key attribute items for analysis of document records. This method comprises the following operations: (a) extracting a master table containing a text string that matches with a specified keyword and identifying an attribute item of the master table under which the match is found; (b) selecting the identified attribute item as a key attribute item; (c) extracting text strings registered under the identified attribute item of the extracted master table for use as search keywords; (d) searching stored document records to extract those containing the search keywords; (e) producing attribute item information associating each of the extracted document records with the search keywords found therein and key attribute items corresponding thereto; and (f) storing the produced attribute item information in a storage device.

Further, to accomplish the third object stated above, the present invention provides a data analyzing apparatus for determining key attribute items for analysis of document records and analyzing the document records based on the determined key attribute items. This apparatus comprises the following elements: (a) a master table search processor that extracts a master table containing a text string that matches with a specified keyword and identifies an attribute item of the master table under which the match is found; (b) a search keyword extractor that extracts text strings registered under the identified attribute item of the extracted master table for use as search keywords, while selecting the identified attribute item as a key attribute item; (c) an attribute item information generator that searches stored document records to extract those containing the search keywords and produces attribute item information associating each of the extracted document records with the search keywords found therein and key attribute items corresponding thereto; (d) an attribute item information storage unit that stores the produced attribute item information; and (e) an analyzer that performs analysis of the document records by using the attribute item information produced by the attribute item information generator.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of an embodiment of the present invention.

FIG. 2 shows an example system structure according to an embodiment of the present invention.

FIG. 3 is a block diagram showing an example hardware structure of an administration terminal according to the present embodiment.

FIG. 4 shows an example software structure according to the present embodiment.

FIG. 5 shows an example of an incident table.

FIG. 6 shows an example of a store master table.

FIG. 7 shows an example of a terminal master table.

FIG. 8 shows an example of a system operator master table.

FIG. 9 shows an example of a master table listing table according to the present embodiment.

FIG. 10 shows an example of a selectable search field table.

FIG. 11 shows an example of an analysis definition management table.

FIG. 12 shows an example of a search field definition table.

FIG. 13 shows an example of a search keyword definition table.

FIG. 14 shows an example of a key attribute item table.

FIG. 15 is a flowchart showing how an analysis server works according to a first embodiment of the invention.

FIG. 16 is a flowchart of a master table search.

FIG. 17 is a flowchart of a process of defining key attribute items.

FIG. 18 is a flowchart of a process of producing a key attribute item table.

FIG. 19 shows an example of an SQL statement for incident table search.

FIG. 20 shows an example of an incident management window.

FIG. 21 shows an example of a key attribute item definition window.

FIG. 22 summarizes definition data produced by a key attribute item definition process.

FIG. 23 shows an example of a key attribute item table produced by a key attribute item table generation process.

FIG. 24 shows an example result of a search initiated from a key attribute item definition window.

FIG. 25 shows an example of an analysis result window, specifically indicating store-by-store error counts.

FIG. 26 shows an example of an analysis result window, specifically showing statistics of errors occurred at Kawasaki store.

FIG. 27 gives another example of an analysis result window, specifically showing statistics of errors occurred at Kawasaki Store in graph form.

FIG. 28 is a flowchart of key attribute item selection according to a second embodiment of the present invention.

FIG. 29 shows an example window including a list of candidates for key attribute items.

FIG. 30 shows a first example of a key attribute item definition window, in which the user selects which operation to perform.

FIG. 31 shows a second example of a key attribute item definition window, in which the user adds a new line.

FIG. 32 shows a third example of a key attribute item definition window, which includes a newly registered search keyword.

### DESCRIPTION OF THE PREFERRED EMBODIMENTS

Preferred embodiments of the present invention will be described below with reference to the accompanying drawings, wherein like reference numerals refer to like elements throughout.

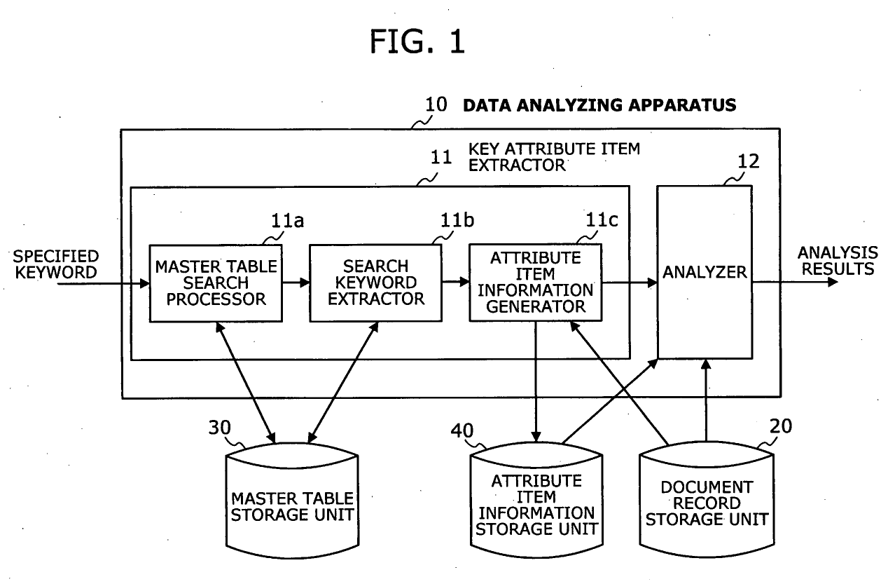

FIG. 1 is a conceptual view of a data analyzing apparatus 10 according to an embodiment of the present invention. This data analyzing apparatus 10 includes a key attribute item extractor 11 for extracting document records for analysis to produce attribute item information, and an analyzer 12 for analyzing events by using the produced attribute item information and other data. The data analyzing apparatus 10 is coupled to a document record storage unit 20, a master table storage unit 30, and an attribute item information storage unit 40. Those processing elements are realized by a computer executing a program designed for determining key attribute items.

The following section will first describe the document record storage unit 20, master table storage unit 30, and attribute item information storage unit 40. Those storage units may be located in a local storage device of the data analyzing apparatus 10, or in a remote storage device under the control of some other system.

The document record storage unit 20 stores and manages a collection of document records, or text data describing a class of events. Document records describe individual events that occurred in the past. Specifically, each record gives details of a particular event, including its cause, date, time, location, and others. The document record storage unit 20 stores those pieces of information in the form of itemized text data. As will be described in a later section, the document records may include incident records describing past incidents.

The master table storage unit 30 contains a set of master tables related to the document records. Master tables are specific to each business system in which document records are collected. A master table is formed from a plurality of columns, or data fields, corresponding to different attribute items. Each data field contains words or combinations thereof (referred to hereafter as “text strings”) to be searched. Master tables store such text strings itemized by attribute. Think of, for example, a master table for a system formed from several specific devices. The master table in this case should contain text strings representing, for example, the names and locations of system components and the name of a person in charge of operation and management of the system.

The term “attribute item” is used here to refer to a specific name representing properties of a class of text strings. In the above example, the attribute items may include “Component Name” and “System Operator,” for example.

The attribute item information storage unit 40 stores attribute item information that associates each document record extracted by using search keywords belonging to a specific attribute item with search keywords found in that document record, as well as with key attribute items corresponding to those search keywords. The details will be described later.

As mentioned earlier, the data analyzing apparatus 10 has a key attribute item extractor 11 and an analyzer 12. The key attribute item extractor 11 is formed from a master table search processor 11a, a search keyword extractor 11b, and an attribute item information generator 11c.

The master table search processor 11a is activated when the user enters a specific keyword for analysis. Upon receipt of such a keyword, the master table search processor 11a searches master tables stored in the master table storage unit 30 in an attempt to extract master tables containing text strings that match with the specified keyword. Based on the extracted master tables, the master table search processor 11a then identifies an attribute item to which the specified keyword belongs.

More specifically, the master table search processor 11a examines each master table by comparing the text strings registered therein with the specified keyword. If a match is found in a master table, the master table search processor 11a extracts that master table as being relevant to the specified keyword. The master table search processor 11a then identifies under which attribute item of the extracted table the specified keyword is found. The master table search processor 11a notifies the search keyword extractor 11b of the extracted master table and attribute item.

There may be two or more master tables that match with the specified keyword. If this is the case, the master table search processor 11a extracts all such master tables and their respective attribute items and sends them all to the search keyword extractor 11b.

The search keyword extractor 11b receives the master table and attribute item extracted by the master table search processor 11a. The search keyword extractor 11b regards this attribute item as a key attribute item and thus extracts other text strings belonging to the key attribute item in the master table. That is, all text strings registered under the same attribute item as that of the specified keyword are extracted for later use as search keywords.

In the case where a plurality of master tables have been extracted by the master table search processor 11a, the search keyword extractor 11b selects one of the corresponding attribute items that is considered to be the most suitable as a key attribute item. The details of this selection will be described later. The above-described operations extract a key attribute item and its corresponding search keywords for use in a later process of selecting document records for analysis.

By using the extracted search keywords, the attribute item information generator 11c retrieves document records out of the document record storage unit 20 to produce attribute item information from the retrieved records. More specifically, the attribute item information generator 11c compares each text string constituting document records with the search keywords, thereby finding document records containing at least one match word. The attribute item information generator 11c extracts such document records as the subject of analysis. The attribute item information generator 11c then compiles attribute item information from those document records, their associated search keywords, and key attribute items corresponding to those search keywords.

The resulting attribute item information is stored in the attribute item information storage unit 40 described earlier. Based on this attribute item information, the analyzer 12 performs statistical analysis on the retrieved document records.

### Key Attribute Items

This section describes how the above-described data analyzing apparatus 10 determines key attribute items according to the present embodiment.

The document record storage unit 20 stores a collection of document records describing a class of events. Those document records may indicate some tendency of events. In an attempt to find such tendency, the user enters a specific keyword for extracting relevant document records. The user is allowed to select any word or phrase for this purpose. It is possible to consult some existing document records to pick up an appropriate word or phrase from those document records.

In response to entry of a specified keyword, the data analyzing apparatus 10 activates its master table search processor 11a to search master tables stored in the master table storage unit 30, thus extracting a master table containing a text string that matches with the specified keyword. Based on the extracted master table, the master table search processor 11a then identifies under which attribute item of the master table the specified keyword is found. The search keyword extractor 11b regards the identified attribute item as a key attribute item and extracts every text string belonging to that key attribute item of the extracted master table. The resulting set of search keywords includes, in addition to the specified keyword itself, all text strings that fall within the same category as the specified keyword.

Suppose, for example, that there is a master table regarding system configuration which contains entries “Device A,” “Device B,” “Device C,” and “Device D” in its attribute item titled “DEVICE NAME.” If the user specifies “Device A” as a keyword, the master table search processor 11a then finds the specified keyword “Device A” in this master table and identifies its corresponding attribute item “DEVICE NAME.” In the case where that master table is the only master table that is found relevant, the search keyword extractor 11b selects “DEVICE NAME” as a key attribute item, thus extracting all corresponding attribute entries “Device A,” “Device B,” “Device C,” and “Device D” as search keywords.

In the case where more than two master tables have been extracted, the search keyword extractor 11b selects one of those master tables that is considered to be the most appropriate. The search keyword extractor 11b then determines a key attribute item and search keywords, based on the selected master table. Optionally, the search keyword extractor 11b may be designed to provide the user with a list of search keywords, together with available attribute items of the extracted master table(s), so that the user can choose a preferable key attribute item and search keywords.

The above-described processing steps automatically extract text strings with the same attribute as that of a specified keyword for use as search keywords. While the above search keyword extractor 11b has selected one key attribute item for analysis, the invention is not limited to that specific example. Rather, two or more attribute items may be selected as key attribute items through a similar process. For example, the search keywords may include “Place a,” “Place b,” “Place c” belonging to another key attribute item named “DEVICE LOCATION.”

The attribute item information generator 11c then retrieves document records from the document record storage unit 20 according to the extracted search keywords. Each retrieved document record contains a search keyword belonging to the key attribute item(s). The attribute item information generator 11c produces attribute item information from combinations of those search keywords and key attribute item(s).

Suppose, for example, that a record of event #1 containing “Device A” is extracted. In this case the attribute item information generator 11c adds to the attribute item information an entry that associates event #1 with a search keyword “Device A” and attribute item “DEVICE NAME.” For another example, suppose that a record of event #2 containing “Device B” and “Place a” is extracted. The attribute item information generator 11c adds an entry that associates event #2 with a search keyword “Device B” and attribute item “Device Name,” as well as with another search keyword “Place a” and attribute item “DEVICE LOCATION.”

The analyzer 12 performs statistical analysis based on the attribute item information by using, for example, Online Analytical Processing (OLAP) applications. The present embodiment uses known techniques for the statistical analysis, and accordingly, this description does not provide details of those techniques.

As can be seen from the above, the proposed data analyzing apparatus 10 performs data analysis based on at least one specified keyword. Upon receipt of such a keyword, the data analyzing apparatus 10 extracts a master table and its attribute item containing the specified keyword. This attribute item is selected as a key attribute item. The data analyzing apparatus 10 further extracts other text strings registered under that attribute item of the extracted master table. The extracted text strings will be used as search keywords.

The above process automatically selects key attribute items and search keywords according to a specified keyword and, based on those attribute items and search keywords, extracts relevant document records for analysis. This feature of the present embodiment eliminates the need for adding classification code previously to document records or defining search keywords individually. The proposed data analyzing apparatus 10 can thus deal with possible changes in the operating environment in a flexible way.

When starting a data analysis, the user has only to specify a keyword representing his/her particular interest. The proposed data analyzing apparatus 10 automatically picks up similar search keywords that are considered to be relevant from the same analytical viewpoint, thus enabling the user to extract as many document records as possible for more effective data analysis.

The next sections will provide more details about the data analyzing apparatus 10, with reference to the accompanying drawings. The description will assume a specific business system as an example application of the present invention. This business system includes business terminals deployed in retail stores or branch offices of a corporation. A business server manages those business terminals and provides them with various business-related services. The system also includes a support center for its operations and management, which has an incident management database to collect and manage the records of incidents (e.g., errors) that the system encountered. The present invention is used in statistical analysis of incident records stored in the incident management database.

### Business Network System

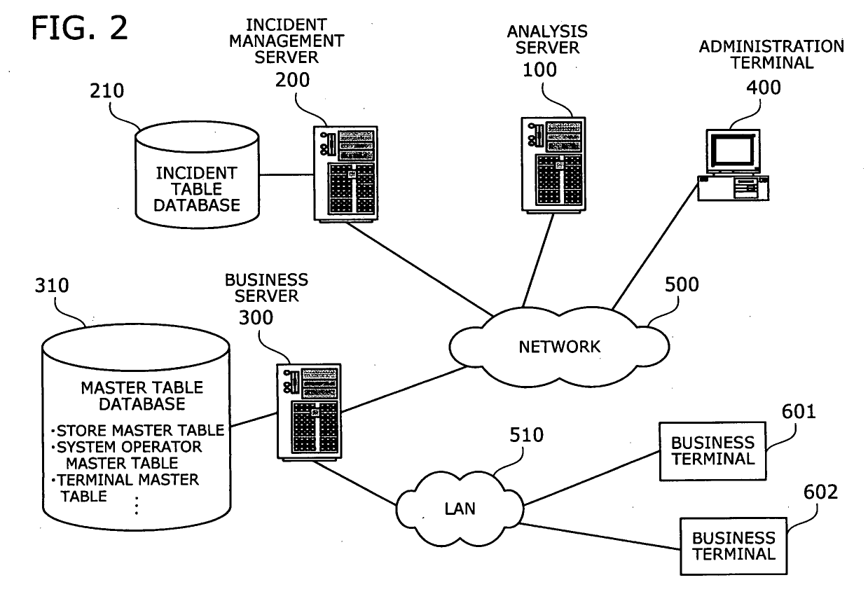

FIG. 2 shows an example system structure according to an embodiment of the present invention. In the illustrated system, an analysis server 100 is connected to an incident management server 200, a business server 300, and an administration terminal 400 via a network 500. The incident management server 200 manages incidents, and the business server 300 manages business activities.

The analysis server 100 is a data analyzing apparatus that performs statistical analysis on the system's incident records stored in an incident table database 210. The analysis server 100 communicates with an administration terminal 400 over the network 500 and executes data analysis according to commands received from the administration terminal 400.

The incident management server 200, together with an incident table database 210 coupled thereto, collects and manages incident records that describe troubles and problems encountered by the system. Each incident record is formed from multiple data items including, among others, the symptom and cause of a trouble and action taken to the trouble. The incident table database 210 stores such incident records by classifying their information elements in separate data fields. A unique incident identifier (ID) is added to each stored incident record so as to distinguish it from others.

The business server 300 is coupled to a master table database 310 that stores various pieces of business-related information. The business server 300 is also connected to business terminals 601 and 602 via a local area network (LAN) 510 to provide business-related services. The business terminals 601 and 602 are, for example, Point of Sale (POS) terminals. While FIG. 2 illustrates only two such terminals, the actual implementation may include as many terminals as each store requires. Likewise, there may be two or more business servers 300 and master table databases 310. The system may also be modified to use the network 500 instead of LAN 510 to interconnect the business terminals 601 and 602 and business server 300.

The master table database 310 stores information that the business server 300 requires for its business-related services, such as data of business terminals under its management. In the example of FIG. 2, the master table database 310 contains a set of master tables including: a store master table enumerating managed stores, a system operator master table providing a list of persons responsible for local business systems, a terminal master table providing details of business terminals 601 and 602.

The administration terminal 400 is used by the system administrator to interact with the analysis server 100, incident management server 200, and business server 300. For example, the system administrator sends commands to, and collects information from, those servers through the administration terminal 400.

### Hardware Platform

This section describes an example hardware structure of the administration terminal 400, as a representative of the terminals and servers deployed in the system of FIG. 2.

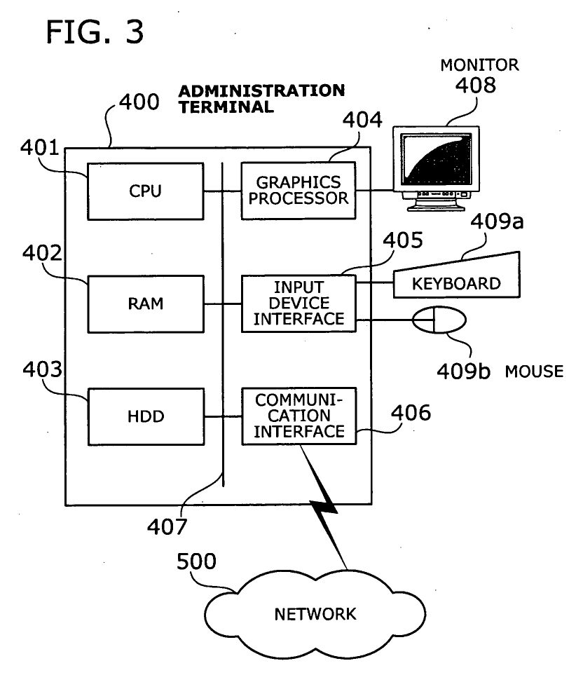

FIG. 3 is a block diagram showing an example hardware structure of the administration terminal 400 according to the present embodiment. The illustrated administration terminal 400 has a CPU 401 for its overall control, which interacts with other elements via a bus 407. Connected to the CPU 401 are: a random access memory (RAM) 402, a hard disk drive (HDD) 403, a graphics processor 404, an input device interface 405, and a communication interface 406. The RAM 402 serves as temporary storage for the whole or part of operating system (OS) programs and application programs that the CPU 401 executes, in addition to other various data objects manipulated at runtime. The HDD 403 stores program and data files of the operating system and applications. The graphics processor 404 produces video images in accordance with drawing commands from the CPU 401 and displays them on the screen of an external monitor 408 coupled thereto. The input device interface 405 is used to receive signals from external input devices, such as a keyboard 409a and a mouse 409b. Those input signals are supplied to the CPU 401 via the bus 407. The communication interface 406 is connected to a network 500, allowing the CPU 401 to exchange data with other computers, such as the analysis server 100, incident management server 200, and business server 300 on the same network 500.

The computer hardware described above serves as a platform for realizing the processing functions of the present embodiment. While FIG. 3 illustrates the administration terminal 400, the same hardware configuration can be applied to the analysis server 100, incident management server 200, business server 300, and business terminals 601 and 602.

### Software Components

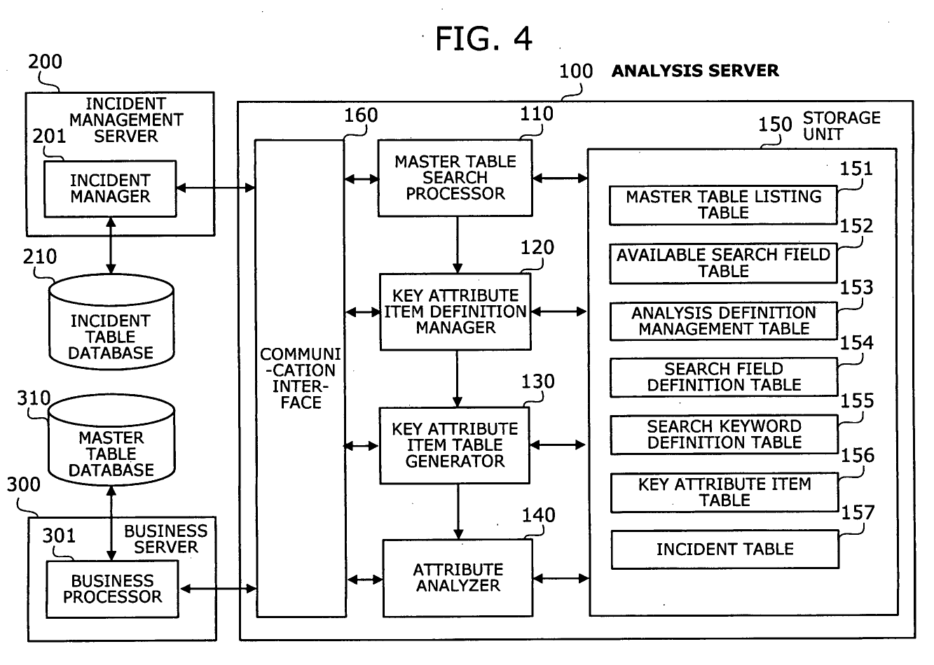

The system shown in FIG. 2 includes various software components (while not explicitly shown). FIG. 4 gives an example software structure according to the present embodiment. Some components shown in FIG. 4 have already been described in FIG. 2. They bear the same reference numerals, and their description will not be repeated here.

The analysis server 100 has, in addition to its local storage unit 150, the following data processing elements: a master table search processor 110, a key attribute item definition manager 120, a key attribute item table generator 130, an attribute analyzer 140, a communication interface 160. Those processing elements of the analysis server 100 are implemented as computer programs; a computer executes them to provide the intended functions of the present invention.

The master table search processor 110 retrieves master tables containing text strings that match with a specified keyword. Master tables are under the management of the business server 300. The analysis server 100, on the other hand, has a master table listing table 151 describing what master tables are stored in which location. By consulting this master table listing table 151, the master table search processor 110 makes access to each master table through the communication interface 160, extracts those containing a specified keyword, and finds an attribute item corresponding to the specified keyword in each extracted master table.

The key attribute item definition manager 120 offers the functions of the search keyword extractor 11b described in an earlier section. Specifically, the key attribute item definition manager 120 produces various definition data, including search keywords for use in producing attribute item information. More specifically, what is produced is: an analysis definition management table 153, a search field definition table 154, and a search keyword definition table 155. The key attribute item definition manager 120 saves those tables in its own storage unit 150. Unless otherwise noted, the term “definition data” will be used to refer to those three definition tables collectively.

Suppose that the key attribute item definition manager 120 has produced definition data and made it available in the storage unit 150. According to this definition data, the key attribute item table generator 130 searches incident records to produce a key attribute item table 156. The produced key attribute item table 156 is saved in the storage unit 150.

The attribute analyzer 140 makes access to the storage unit 150 to read the key attribute item table 156 that has been produced by the key attribute item table generator 130. The attribute analyzer 140 then performs data analysis according to this key attribute item table 156.

The storage unit 150 stores a master table listing table 151, a selectable search field table 152, an analysis definition management table 153, a search field definition table 154, a search keyword definition table 155, a key attribute item table 156, and an incident table 157. The master table listing table 151 is a collection of locators indicating where each master table can be found. The selectable search field table 152 gives information about which data fields of incident records can be subjected to a keyword search. The analysis definition management table 153 gives the names of key attribute items that are selected. The search field definition table 154 defines the data fields of incident records on which a keyword search will actually take place. The search keyword definition table 155 is a collection of search keywords that are selected. The key attribute item table 156 corresponds to what was discussed earlier as “attribute item information,” or the outcome of the key attribute item table generator 130. The incident table 157 is a copy of incident records stored in the incident table database 210. The details of those tables will be described in later sections.

The communication interface 160 receives an incident table from the incident management server 200, as well as master tables from the business server 300, via the network 500. The communication interface 160 also forwards commands from the administration terminal 400 (not shown in FIG. 4) to relevant processing elements of the analysis server 100, as well as transmitting view data produced by the processing elements to the administration terminal 400.

The incident management server 200 has an incident manager 201 that collects incident records and manages them in an incident table database 210. Upon request from the analysis server 100, the incident manager 201 reads incident records out of the incident table database 210 and supplies them to the requesting processing element of the analysis server 100.

The business server 300 includes a business processor 301 that provides various business-related services by using information stored in a master table database 310. Upon request from the analysis server 100, the business processor 301 reads master tables out of the master table database 310 and supplies them to the requesting processing element of the analysis server 100.

### Incident Records and Master Tables

This section describes by way of example the details of incident records stored in the incident table database 210 and master tables stored in the master table database 310.

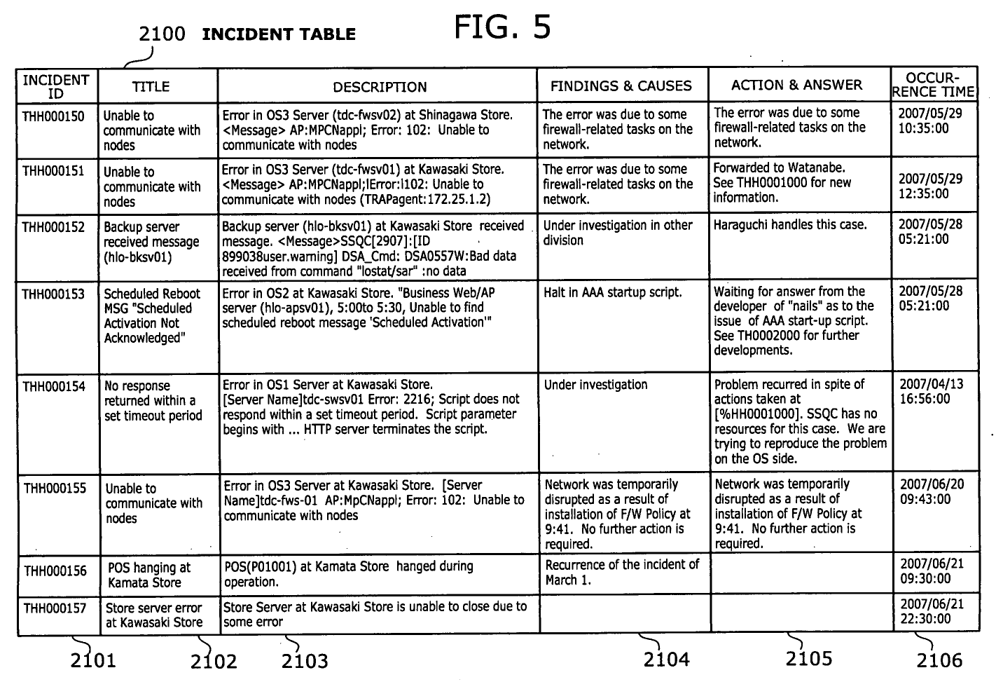

FIG. 5 shows an example of an incident table. The illustrated incident table 2100 gives a collection of incident records each describing a trouble or like event that happened in a specific subject system. Each incident record is formed from the following data fields: INCIDENT ID 2101, TITLE 2102, DESCRIPTION 2103, FINDINGS & CAUSES 2104, ACTION & ANSWER 2105, and OCCURRENCE TIME 2106. Incident records are uniquely identified by the values shown in their respective INCIDENT ID fields 2101. The TITLE field 2102 and DESCRIPTION field 2103 provide a brief description (or title) and a detailed description of an incident, respectively. The FINDINGS & CAUSES field 2104 shows what was investigated and found with regard to the incident. The ACTION & ANSWER field 2105 describes what action was taken and/or what answer was returned to the inquirer (if any) with regard to the incident. The OCCURRENCE TIME field 2106 indicates when the incident occurred.

Each data field contains specific text data describing an incident. See, for example, the topmost incident record shown in FIG. 5. This incident record has an identifier of “THH000150” in its INCIDENT ID field 2101, a title that reads “Unable to communicate with nodes” in its TITLE field 2102, a description that reads “Error in OS3 Server (tdc-fwsv02) at Shinagawa store. <Message> AP:MPCNappl; ERROR: 102: Unable to communicate with nodes” in its DESCRIPTION field 2103. Further, both FINDINGS & CAUSES field 2104 and ACTION & ANSWER field 2105 give a note that reads: “The error was due to some firewall-related tasks on the network.” The OCCURRENCE TIME field 2106 gives a time stamp of “2007/05/29 10:35:00” indicating the date and time at which this incident occurred.

The operator enters each of those data items when registering an incident record. When a new record entry is received from the operator, the incident management server 200 registers it with the incident table 2100 by distributing each part of given text data to its corresponding data field and adding a unique incident ID to the entire record. Note that the incident management server 200 does not require the operator to assign a classification code or the like to incident records at this registration stage, thus alleviating his/her workload. Reduced data entry time leads to reduced cost of operations.

Before starting data analysis, the analysis server 100 fetches a relevant incident table from the incident table database 210 through the incident management server 200 and stores it as its local incident table 157. Since the original incident table does not change once it is registered, the analysis server 100 can achieve the purpose by using the local copy in the storage unit 150, taking advantage of its shorter access times. The present embodiment, however, does not prevent the analysis server 100 from making direct access to the incident table database 210 during the course of data analysis.

The master table database 310 contains a store master table, a terminal master table, and a system operator master table. The business server 300 updates those tables, as necessary, to provide business-related services. Each master table offers information about a specific subject area (e.g., store, terminal, system operator) in tabular form. The columns of a master table represent specific attribute items. In other words, the data placed in a particular column is characterized by a particular attribute. Each row of a master table gives a collection of data about a single incident. In the rest of this description, the term “attribute value” will be used to refer to the data stored in each data field (as opposed to the attribute item, or the name of attribute).

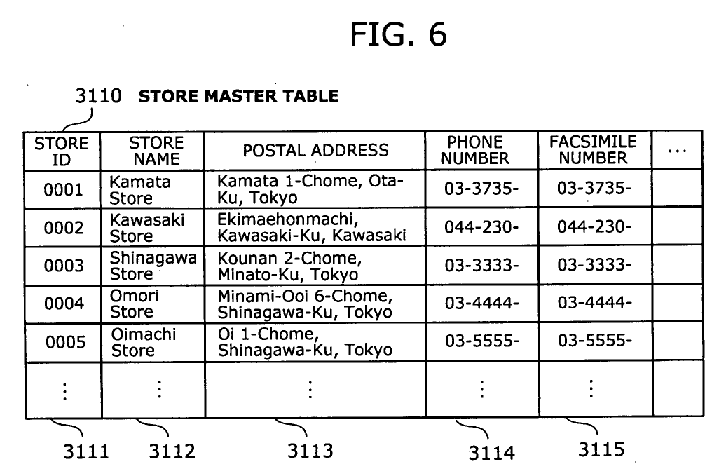

FIG. 6 shows an example of a store master table. The illustrated store master table 3110 provides various pieces of information about stores involved in a business system. Specifically, this store master table 3110 has, among others, the following attribute items: STORE ID 3111, STORE NAME 3112, POSTAL ADDRESS 3113, PHONE NUMBER 3114, and FACSIMILE NUMBER 3115.

The STORE ID field 3111 contains an ID code uniquely assigned to each store. In the example of FIG. 6, attribute values “0001” to “0005” represent five different stores. The STORE NAME field 3112 gives the name of each store. Likewise, the POSTAL ADDRESS field 3113, PHONE NUMBER field 3114, and FACSIMILE NUMBER field 3115 give the postal address, phone number, and facsimile number of the store, respectively. See the topmost entry of the store master table 3110, for example. The attribute values of this entry show that “Kamata Store” with a store ID of “0001” is located in “Kamata 1-Chome, Ota-Ku, Tokyo,” with a phone number “03-3735- . . . ” and a facsimile number “03-3735- . . . ”

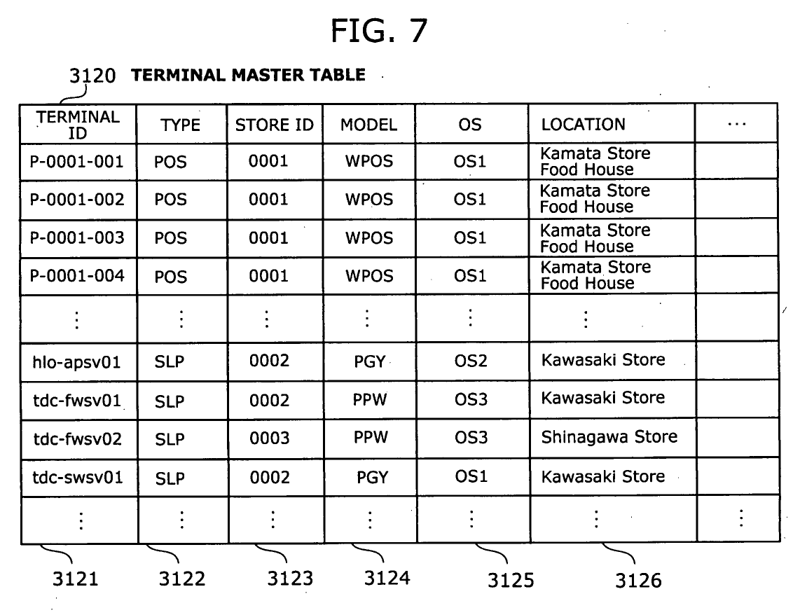

FIG. 7 shows an example of a terminal master table. The illustrated terminal master table 3120 describes terminals located in each store. Specifically, the terminal master table 3120 is formed from the following attribute items: TERMINAL ID 3121, TYPE 3122, STORE ID 3123, MODEL 3124, OS 3125, and LOCATION 3126.

The TERMINAL ID field 3121 contains an ID code uniquely assigned to each terminal. Such ID codes are system-specific information, which may be found nowhere but in the master tables. In other words, they are proper names only valid in a local workplace. It is, therefore, hard for the user to specify them beforehand as search keywords.

The TYPE filed 3122 gives the type of a terminal identified by the corresponding TERMINAL ID field 3121. The STORE ID field 3123 contains a store ID that indicates in which store the terminal is placed. This store ID is found in the STORE ID field 3111 of the store master table 3110 (FIG. 6). The MODEL field 3124 shows the model of the terminal. The OS field 3125 indicates which operating system is running on the terminal. The LOCATION field 3126 indicates where in the store the device is located. See, for example, the topmost entry of the terminal master table 3120. The attribute values of this table entry show that a POS terminal with a terminal ID of “P-0001-001” is deployed in the store identified by store ID “0001.” The model of this terminal is “WPOS,” on which the operating system “OS1” is running. The terminal is located in “Kamata Store, Food House.”

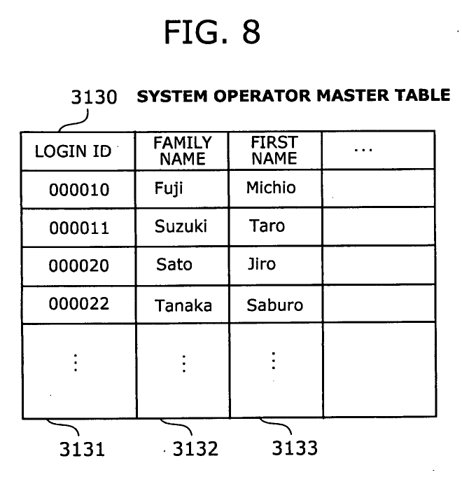

FIG. 8 shows an example of a system operator master table. This system operator master table 3130 stores information about the persons in charge of system management. Specifically, the system operator master table 3130 has the following attribute items: LOGIN ID 3131, FAMILY NAME 3132, and FIRST NAME 3133. In the case where the system is implemented with the Japanese language, the system operator master table 3130 may be modified to have additional attribute items for the first names and family names written in Kanji and/or Katakana characters.

The LOGIN ID field 3131 contains a unique ID assigned to each system operator. The FAMILY NAME field 3132 and first name field 3133 contain family and first names of the person identified by the login ID field 3131. For example, the topmost table entry describes a system operator, Michio Fuji, with a login ID “000010.”

As mentioned earlier, those master tables are maintained in the master table database 310 under the control of the business server 300. The analysis server 100 reads out the latest version of master tables for analysis. In actual implementations, however, master tables are often stored in a plurality of distributed storage devices. To enable access to such distributed master tables, the analysis server 100 stores the links or pointers to those master tables in a master table listing table 151.

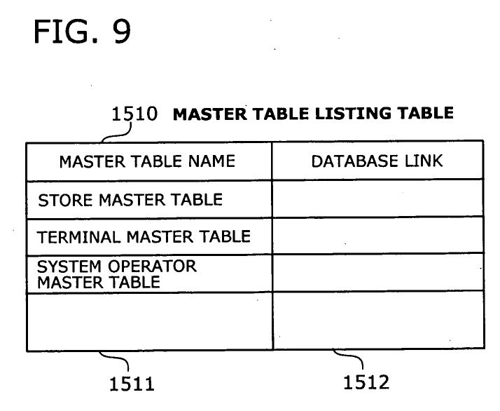

FIG. 9 shows an example of the master table listing table 151 according to the present embodiment. The illustrated master table listing table 1510 has the following data fields: MASTER TABLE NAME 1511, and DATABASE LINK 1512. The DATABASE LINK field 1512 provides the location of a master table database in the form of, for example, Uniform Resource Locator (URL), so that the analysis server 100 can make access to desired master tables in a remote location.

### Other Tables in Analysis Server

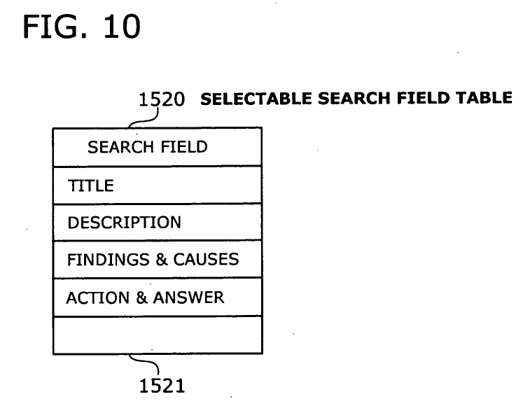

The analysis server 100 has more tables in its storage unit 150. FIG. 10 shows an example of a selectable search field table. This selectable search field table 1520 enumerates, in its column named SEARCH FIELD 1521, the data fields of incident records that can be subjected to a keyword search. Recall that the incident table of FIG. 5 has six data fields. As can be seen from the selectable search field table 1520 of FIG. 10, the analysis server 100 is only allowed to search the following four data fields: TITLE, DESCRIPTION, FINDINGS & CAUSES, and ACTION & ANSWER. Since there is no chance for the other two data fields to contain a search keyword, the selectable search field table 1520 excludes them from the search range, thus making a search process more efficient. While FIG. 10 shows a single set of search fields, it is also possible to provide two or more such sets of search fields, depending on which attribute item of master tables is selected.

The above-described master table listing table 151 and selectable search field table 152 are defined before the key attribute item definition manager 120 begins its processing. The key attribute item definition manager 120 produces an analysis definition management table 153, a search field definition table 154, and a search keyword definition table 155. As mentioned earlier, these three tables serve as definition data related to key attribute items.

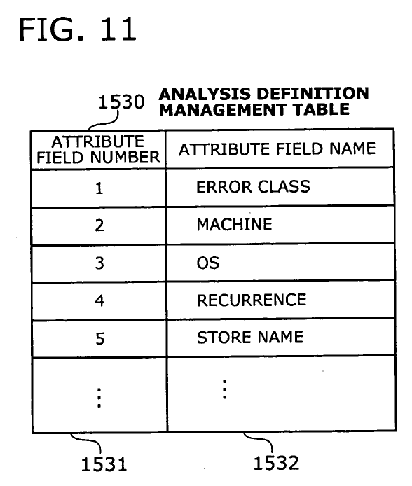

FIG. 11 gives a specific example of an analysis definition management table. The illustrated analysis definition management table 1530 is formed from the following data fields: ATTRIBUTE FIELD NUMBER 1531 and ATTRIBUTE FIELD NAME 1532. The analysis definition management table 1530 enumerates key attribute items determined by the key attribute item definition manager 120.

The analysis definition management table 1530 will be used as one of the sources for a key attribute item table 156. To summarizes the results of incident record search with respect to different attribute items, the key attribute item table 156 is organized by rows and columns representing incident IDs and attribute items, respectively. In this context, the ATTRIBUTE FIELD NUMBER field 1531 of the analysis definition management table 1530 gives the column numbers of attribute items. Those ATTRIBUTE FIELD NUMBERs also serve as unique identifiers of key attribute items used in data analysis.

The ATTRIBUTE FIELD NAME field 1532, on the other hand, gives the names of key attribute items obtained from master tables containing a specified keyword. For example, the third entry of the analysis definition management table 1530 shows an attribute field name “OS” associated with an attribute field number “3.” This table entry corresponds to the OS field 3125 of the terminal master table 3120 (FIG. 7). Attribute “OS” has been found and selected as a key attribute item.

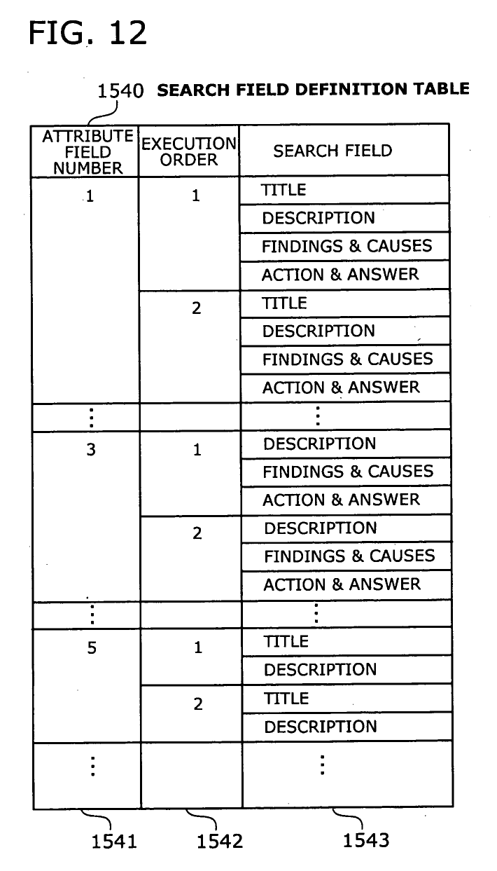

FIG. 12 gives a specific example of a search field definition table. The illustrated search field definition table 1540 is formed from the following data fields: ATTRIBUTE FIELD NUMBER 1541, EXECUTION ORDER 1542, and SEARCH FIELD 1543. This search field definition table 1540 summarizes search ranges determined by the key attribute item definition manager 120. The ATTRIBUTE FIELD NUMBER field 1541 corresponds to the foregoing ATTRIBUTE FIELD NUMBER field 1531 of the analysis definition management table 1530. The EXECUTION ORDER field 1542 defines the execution order of a search using a specific search keyword. The value of this field is actually a unique identifier assigned to each different search keyword extracted under the same key attribute item. The SEARCH FIELD field 1543 gives a search range, i.e., a range of data fields to be searched with the search keyword identified by the attribute field number field 1541 and execution order field 1542.

As mentioned, the SEARCH FIELD field 1543 is defined for each different search keyword, based on the entries of the selectable search field table 1520. Think of, for example, a search keyword identified by the combination of ATTRIBUTE FIELD NUMBER=1 and EXECUTION ORDER=1. The topmost part of the search field definition table 1540 means that the analysis server 100 is supposed to search the TITLE, DESCRIPTION, FINDINGS & CAUSES, and ACTION & ANSWER fields of incident records by using that search keyword.

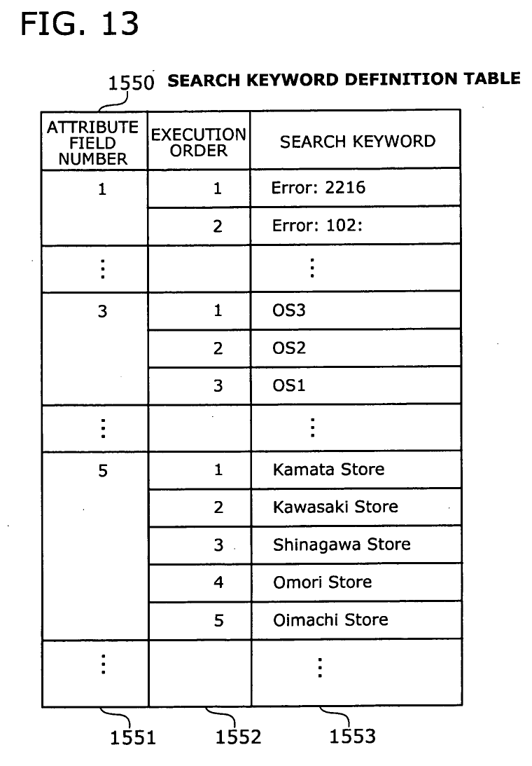

FIG. 13 shows an example of a search keyword definition table. This search keyword definition table 1550 is formed from the following data fields: ATTRIBUTE FIELD NUMBER 1551, EXECUTION ORDER 1552, and SEARCH KEYWORD 1553. The search keyword definition table 1550 summarizes search keywords extracted by the key attribute item definition manager 120. The ATTRIBUTE FIELD NUMBER field 1551 and EXECUTION ORDER field 1552 are identical to the ATTRIBUTE FIELD NUMBER field 1541 and EXECUTION ORDER field 1542 of the foregoing search field definition table 1540 (FIG. 12). The SEARCH KEYWORD field 1553 gives specific text strings selected as search keywords. See, for example, the topmost entry of this search keyword definition table 1550. This table entry shows that a search keyword “Error: 2216” is identified by the combination of ATTRIBUTE FIELD NUMBER=1 and EXECUTION ORDER=1.

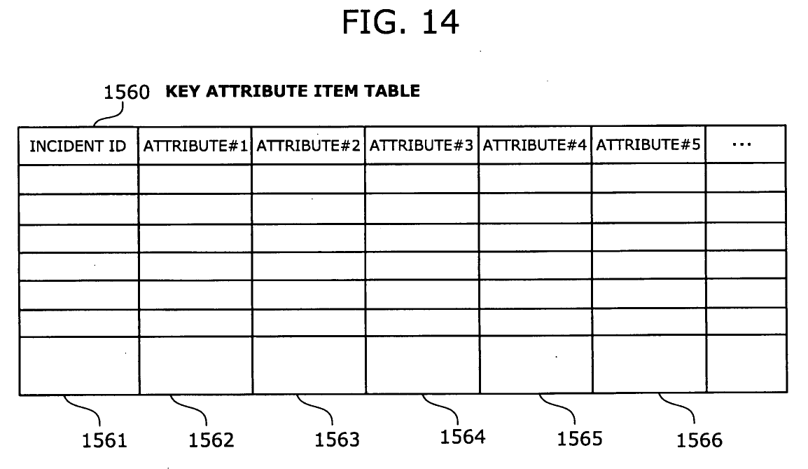

The key attribute item definition manager 120 produces the above definition data, which is used together with the incident table 157 by the key attribute item table generator 130 to create a key attribute item table 156. FIG. 14 shows an example of a key attribute item table. The illustrated key attribute item table 1560 is formed from the following data fields: INCIDENT ID 1561, ATTRIBUTE #1 1562, ATTRIBUTE #2 1563, ATTRIBUTE #3 1564, ATTRIBUTE #4 1565, and ATTRIBUTE #5 1566. This key attribute item table 1560 summarizes search results of the key attribute item table generator 130 as follows.

The INCIDENT ID field 1561 contains the incident ID of each extracted incident record. The ATTRIBUTE fields 1562-1566 contain search keywords found in their corresponding attribute items. ATTRIBUTE #1 refers to the attribute identified by attribute field number “1.” Likewise, #2 to #5 denote attribute field numbers “2” to “5.” As defined in the analysis definition management table 1530 (FIG. 11), ATTRIBUTE #1 corresponds to attribute item “ERROR CLASS.” If an incident record contains a search keyword that falls in this ERROR CLASS category, the search keyword will be entered to ATTRIBUTE #1 field of the table entry corresponding to that incident record. The details will be described in a later section.

The following sections will describe in detail how the proposed analysis server 100 performs data analysis. Stated briefly, the description will present three embodiments of the present invention. In a first embodiment, the analysis server 100 determines key attribute items and search keywords full-automatically by searching master tables upon receipt of a specified keyword. In a second embodiment, the analysis server 100 provides the user with a list of candidates for key attribute items and determines search keywords semi-automatically according to user commands. In a third embodiment, the analysis server 100 helps the user to select search keywords manually.

### First Embodiment

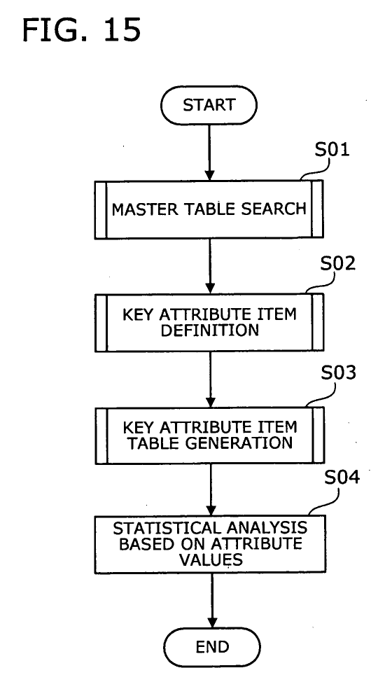

This section describes a first embodiment of the present invention. FIG. 15 is a flowchart showing how the proposed analysis server 100 operates according to the first embodiment. Suppose now that the user has entered a specific keyword, together with an attribute field number for that keyword. Upon receipt of this user input, the analysis server 100 begins the following process:

(Step S01) The process performs a master table search. Specifically, the process examines master tables managed in the business server 300 to extract every master table containing a text string that matches with the specified keyword. The process also determines under which attribute item of the extracted master table the specified keyword is found.

(Step S02) The process defines key attribute items, based on the master table and attribute item found at step S01 to be relevant to the specified keyword. In the case where two or more mater tables are extracted at step S01, the process follows a predetermined priority policy in selecting a single master table for determining a key attribute item (the details will be described later). The process uses this attribute item as a key attribute item and extracts therefrom all the registered text strings as search keywords, thus producing definition data corresponding to the specified attribute number.

(Step S03) The process generates a key attribute item table. Specifically, the process searches an incident table 157 for the search keywords selected at step S02, thereby extracting a set of incident records for analysis. The extracted incident records are entered in a key attribute item table 156, together with their corresponding search keywords.

(Step S04) The analysis server 100 performs a statistical analysis on the attribute values summarized in the key attribute item table 156 produced at step S03.

The details of each step of this flowchart will be described in the following sections.

### Master Table Search

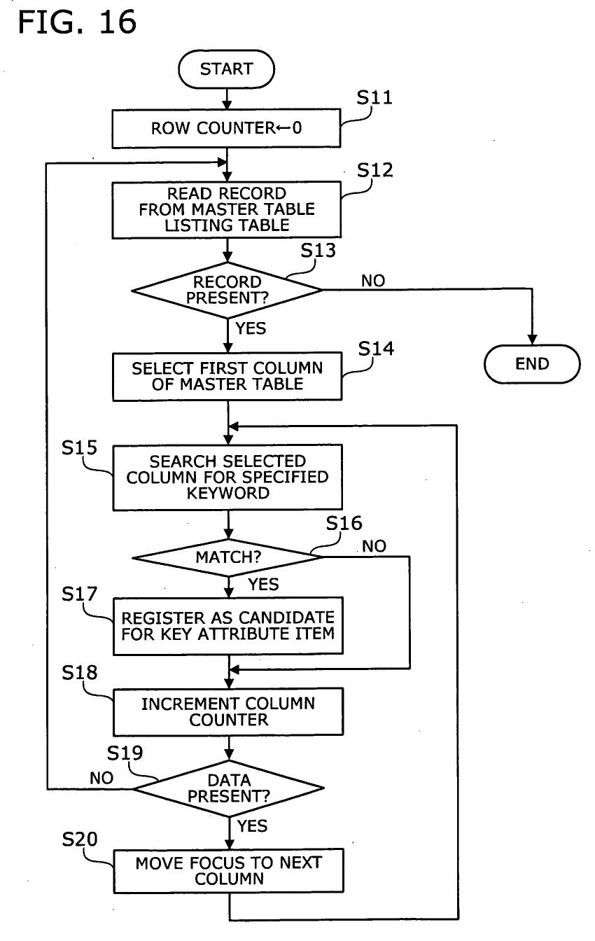

Referring to the flowchart of FIG. 16, the master table search of step S01 is executed according to the following steps:

(Step S11) The process initializes a row counter to zero. This row counter serves as a pointer to the currently focused record (row) of the master table listing table 1510.

(Step S12) The process fetches a record from the master table listing table 1510. More specifically, the process reads a master table name and a database link from the record pointed to by the row counter.

(Step S13) It is determined whether the step S12 has read a valid record of the master table listing table 1510. If so, the process advances to step S14. If not, then it means that all master tables registered in the master table listing table 1510 have been searched. The process is terminated accordingly.

(Step S14) The process fetches a master table according to the record read at step S12 and selects its leftmost column as a search range. Specifically, the process uses a column counter as a pointer that indicates which column (or data field) of the master table is currently selected as a search range. Step S14 initializes this column counter to zero.

(Step S15) The process scans the selected column in an attempt to find a specified keyword. Specifically, the process reads text strings out of the selected column of master table and compares each of them with the specified keyword.

(Step S16) The process determines whether there is a text string that matches with the specified keyword. If there is a match, the process advances to step S17. If there are no matches, the process skips to step S18.

(Step S17) Now that a match is found, the process registers its corresponding attribute item as a candidate for a key attribute item.

(Step S18) The process increments the column counter by one, thus advances the pointer to the next column of the master table.

(Step S19) The process determines whether there is a new data in the column pointed to by the column counter. If there is, the process advances to step S20. If not, the process returns to step S12, while incrementing the row counter by one to select another master table.

(Step S20) The process moves its focus to the next column of the currently selected master table and goes back to step S15.

The above processing steps search every attribute item (column) of every master table registered in the master table listing table 1510, so as to extract master tables and attribute items that match with a specified keyword. The extracted attribute items are referred to as candidate attribute items.

### Key Attribute Item Definition

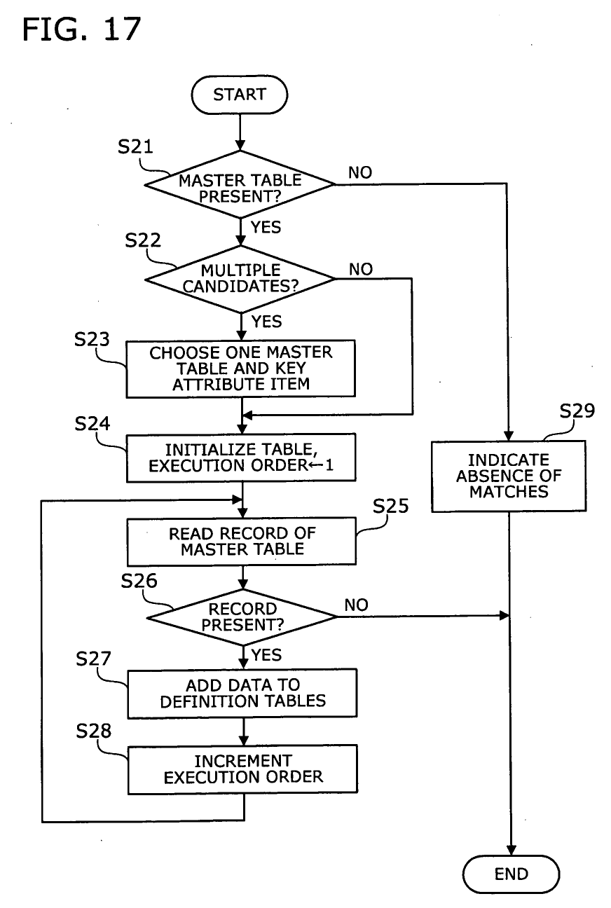

Referring now to FIG. 17, this section will provide details of the key attribute item definition process called at step S02. This process uses the outcomes of step S01, which include extracted master tables and attribute items (i.e., candidate attribute items). FIG. 17 is a flowchart showing how to define a key attribute item.

(Step S21) The process determines whether the preceding master table search has successfully extracted a master tables and candidate attribute items with respect to the specified keyword. If not (i.e., if none of the master tables contains the specified keyword), the process goes to step S29. Otherwise, the process proceeds to step S22.

(Step S22) The process determines whether there are two or more master tables and candidate attribute items. If so, the process advances to step S23. If there is only one candidate, the process skips to step S24, selecting the only master table as a reference master table and the only candidate attribute item as a key attribute item.

(Step S23) The process selects one of the multiple candidate attribute items, based on a predetermined policy. For example, this selection may rely on how many search keywords are identical with the specified keyword. Some search keywords extracted from a matching attribute item may be identical with the specified keyword, while the others are not. Frequent appearance of the same keyword in an attribute item implies less significance thereof. Accordingly, the process avoids such attribute items and chooses a candidate attribute item having only one instance of the specified keyword in its corresponding search keywords. This method is referred to as a significance-based selection policy. Another method is to choose a candidate attribute item with the widest variety of search keywords. The coverage of an incident record search depends on the variety of search keywords (i.e., the variety of extracted text strings). This alternative method is, therefore, referred to as a variety-based selection policy. In this way, the process selects the most appropriate attribute item for analysis, depending on the significance or variety of search keywords. Subsequently the process adds the attribute field name of the selected attribute item to the analysis definition management table 1530 (FIG. 11). Note that the present embodiment is not limited to the two selection method described above. Rather, it is allowed to choose other selection method, depending on the circumstances.

(Step S24) Now that the preceding steps have selected a reference master table and key attribute item, the process begins a process of extracting search keywords from them. Based on the selected master table and key attribute item, the process first initializes relevant data fields of a search field definition table 154 and search keyword definition table 155, setting a value of one to the column titled “EXECUTION ORDER.”

(Step S25) The process reads text data of a new record from the key attribute item of the reference master table. If this is the first round of step S25 after initialization, the process reads the topmost record of the reference master table.

(Step S26) The process determines whether step S25 has obtained a valid record. If no record is present, then it means that all available keywords have been registered and, accordingly, the process is terminated. If a record is present, the process advances to step S27.

(Step S27) The process draws out text strings from the master table record read at step S25 and adds them to the search keyword definition table 155 for use as search keywords, together with their corresponding attribute field number and execution order. The process further selects data items (search fields) of incident records to be searched, and adds them to the search field definition table 154, together with their corresponding attribute field number and execution order. The search fields are previously defined for each attribute item. Or, alternatively, the user may specify which items to register.

(Step S28) The process increments “EXECUTION ORDER” by one before returning to step S25 to proceed to the next record.

(Step S29) Since there is no attribute item containing the specified keyword, the process is terminated after sending a message “no matches found” to the user.

Through the above processing steps, the analysis server 100 reads a key attribute item of a reference master table and extract therefrom text strings. Since those text strings have the same attribute as that of the specified keyword, they are extracted for use as search keywords and registered as part of the definition data for analysis.

### Key Attribute Item Table Generation

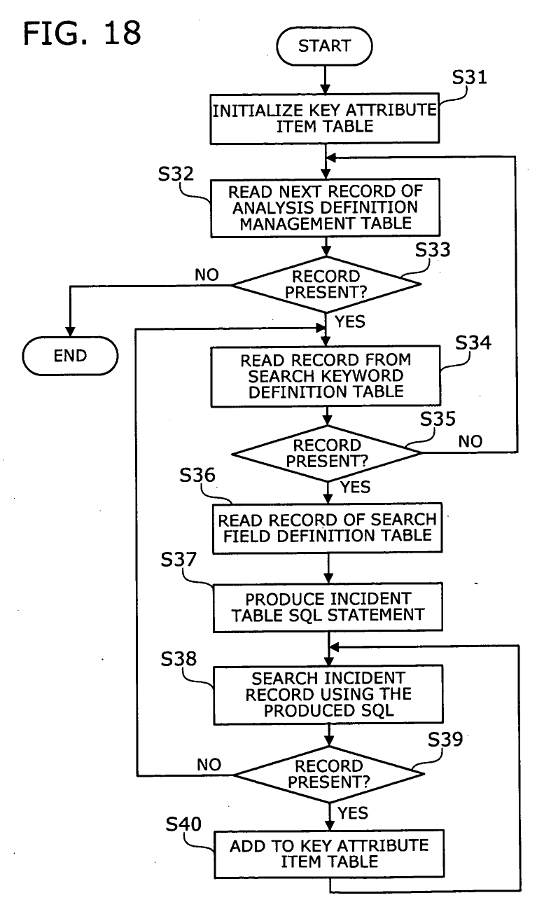

Referring to the flowchart of FIG. 18, this section describes in detail how the foregoing step S03 produces a key attribute item table. The outcomes of step S02 include key attribute items and its corresponding search keywords. Using those search keywords, the process at step S03 retrieves incident records to create a key attribute item table from the extracted incident records and their associated search keywords and key attribute items. FIG. 18 is a flowchart showing how to produce a key attribute item table.

(Step S31) The process initializes a key attribute item table 156 by clearing all existing records, if any.

(Step S32) The process reads a new record of ATTRIBUTE FIELD NAME from the analysis definition management table 1530 according to the order of ATTRIBUTE FIELD NUMBER 1531. If this is the first round of step S32, the process reads a record having the smallest ATTRIBUTE FIELD NUMBER (i.e., “1”).

(Step S33) The process determines whether step S32 has obtained a valid record. If a record is present, the process advances to step S34. If no record is present, then it means that all attribute fields have been finished and, accordingly, the process is terminated.

(Step S34) With the current ATTRIBUTE FIELD NUMBER and current EXECUTION ORDER, the process reads a record of search keyword from the search keyword definition table 1550 (FIG. 13). If this is the first round of step S34 just after the current ATTRIBUTE FIELD NUMBER is set, the process reads a search keyword with an EXECUTION ORDER of “1.” Afterwards, the process increments EXECUTION ORDER by one each time it repeats step S34.

(Step S35) The process determines whether step S34 has obtained a valid record of search keyword. If a record is present, the process advances to step S36. If not, the process goes back to step S32 to proceed to the next ATTRIBUTE FIELD NUMBER.

(Step S36) Based on the ATTRIBUTE FIELD NUMBER and EXECUTION ORDER corresponding to the search keyword obtained at step S34, the process retrieves every relevant SEARCH FIELD record from the search field definition table 1540. As a result, the process has obtained all SEARCH FIELD records corresponding to the search keyword.

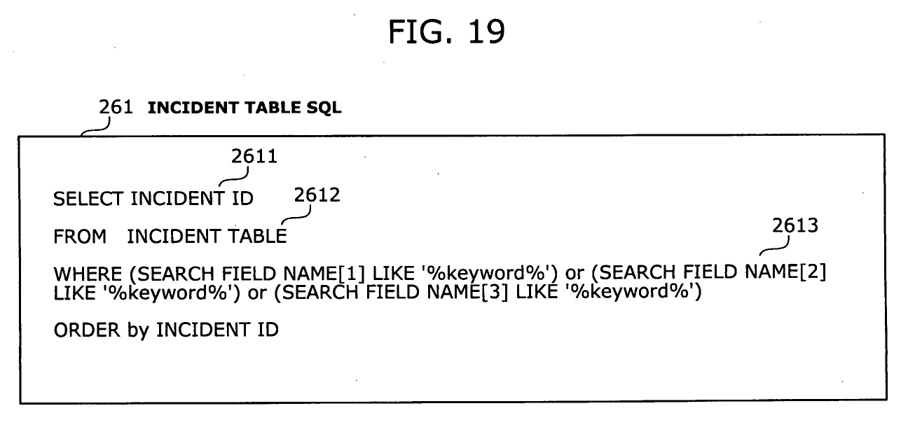

(Step S37) Using the obtained records, the process compiles an incident table SQL statement. FIG. 19 shows an example of an incident table SQL statement. This example incident table SQL 261 is a SELECT statement used to select data from a table. The SELECT clause 2611 specifies “INCIDENT ID” for the name of a column from which data is to be extracted. The FROM clause 2612 specifies “INCIDENT TABLE” for the name of a table to be searched. The WHERE clause 2613 describes search conditions. In the example of FIG. 19, the WHERE clause 2613 requests that SEARCH FIELD NAME[1] be tested first as to whether it matches with a search keyword % keyword %, and that the search should proceed to the next SEARCH FIELD NAME[2] and then to SEARCH FIELD NAME[3]. Note that the character string % keyword % will actually be replaced with a search keyword given at step S34. In addition, the SEARCH FIELD NAME will actually be replaced with a record of search field that is read at step S36.

(Step S38) Using the incident table SQL statement produced at step S37, the process begins a search on another incident record of the incident table 157. The process moves its focus to the next incident record each time the process revisits this step S38.

(Step S39) The process determines whether the step S38 has found a record for the key attribute item table 1560. If so, the process advances to step S40. If no new record is present, then the process returns to step S34 to execute a search with the next search keyword.

(Step S40) With respect to the incident record found at step S38, the process enters the attribute value to a cell of the key attribute item table 1560 that corresponds to the attribute field number. In the case, for example, the attribute field number is “1,” the attribute value (i.e., search keyword) is entered to a cell at the column position of ATTRIBUTE#1 1562 on the row corresponding to the current incident ID.

The above processing steps populate the key attribute item table 1560 with specific attribute values. The next section will describe the operation of the proposed analysis server 100 by way of specific example.

### Operation of First Embodiment

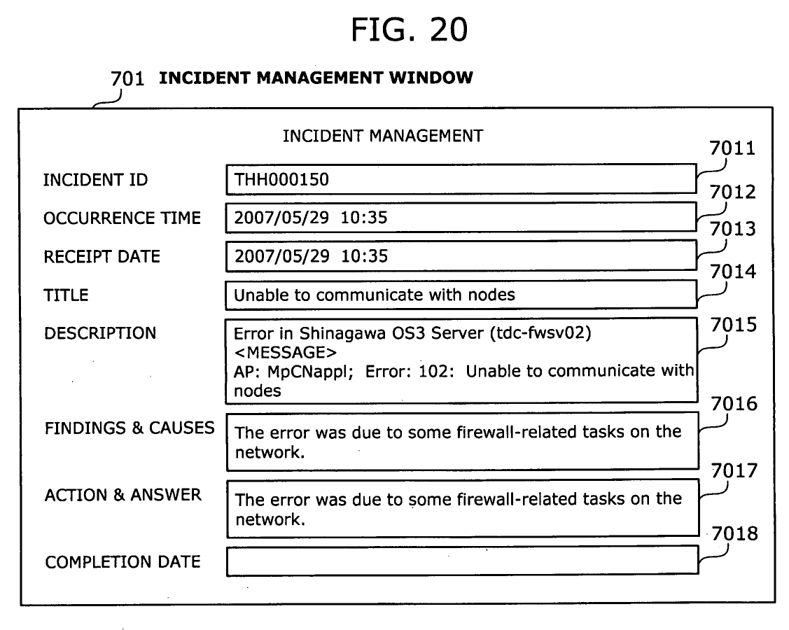

The user sitting at the administration terminal 400 browses an incident management window on its monitor 408. This incident management window is part of incident management functions that the incident management server 200 offers. Suppose now that the user is to select and specify a keyword out of the text strings listed on the terminal screen. FIG. 20 shows an example of an incident management window. The illustrated incident management window 701 shows a specified incident record in the text boxes corresponding to its data fields. More specifically, this example screen includes the following text boxes: INCIDENT ID 7011, OCCURRENCE TIME 7012, RECEIPT DATE 7013, TITLE 7014, DESCRIPTION 7015, FINDINGS & CAUSES 7016, ACTION & ANSWER 7017, and COMPLETION DATE 7018. Each of those text boxes contains a text value of the corresponding data field of the incident record. The example shown in FIG. 20 is an incident record with an incident ID of “THH000150” stored in the incident table 2100.

The user browses the above incident management window 701 and picks up a specific text string from the text boxes for use as a keyword. For example, the user copies a word on this window and pastes it on an appropriate part of a key attribute item definition window provided by the analysis server 100. The following section will describe the case where the user specify a keyword “Shinagawa Store” from the DESCRIPTION text box 7015 by using a copy-and-paste technique.

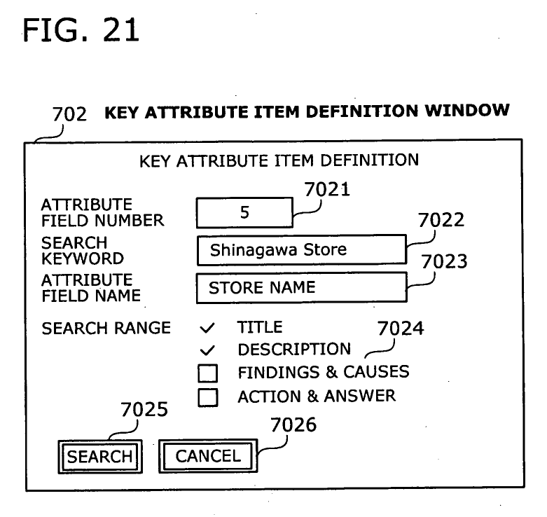

FIG. 21 shows an example of a key attribute item definition window. The illustrated key attribute item definition window 702 has the following text boxes: ATTRIBUTE FIELD NUMBER 7021, SEARCH KEYWORD 7022, and ATTRIBUTE FIELD NAME 7023. Also included in the same window are a SEARCH RANGE list 7024, a SEARCH button 7025, and a CANCEL button 7026.

The ATTRIBUTE FIELD NUMBER text box 7021 indicates in which data field (or column) the attribute item of interest will be placed. The analysis server 100 may give this number automatically by choosing the smallest unused number at that time.

The SEARCH KEYWORD text box 7022 shows a specified keyword. The example of FIG. 21 assumes that the user has copy-and-pasted a text string “Shinagawa Store” from the foregoing incident management window 701. The data entry to this SEARCH KEYWORD text box 7022 invokes a search for a master table and its attribute item (or attribute field) containing “Shinagawa Store.”

The master table search processor 110 thus makes access to a store master table 3110, terminal master table 3120, and system operator master table 3130 according to the master table listing table 151 in an attempt to extract a master table containing a text string that matches with the specified keyword “Shinagawa Store.” In the present case, the master table search processor 110 finds “Shinagawa Store” under the attribute item “STORE NAME” of the store master table 3110. Accordingly, “STORE NAME” is selected as a candidate attribute item. The same keyword is also found in the terminal master table 3120, under another attribute item “LOCATION” 3126. Accordingly, “LOCATION” is selected as another candidate. The master table search processor 110 provides the extracted master tables and attribute items to the key attribute item definition manager 120.

The key attribute item definition manager 120 selects one master table and one candidate attribute item out of those provided from the master table search processor 110, based on, for example, a variety-based selection policy. Here the term “variety” refers to how many different keywords are listed under a particular attribute item. See, for example, the STORE NAME attribute 3112 of the store master table 3110 shown in FIG. 6. This attribute item offers five different keywords: “Kamata Store,” “Kawasaki Store,” “Shinagawa Store,” “Omori Store,”, and “Oimachi Store.” On the other hand, the LOCATION attribute 3126 of the terminal master table 3120 (FIG. 7) offers three different keywords: “Kamata Store Food House,” “Kawasaki Store,” and “Shinagawa Store.” In this case, the key attribute item definition manager 120 chooses “STORE NAME” as a key attribute item since “STORE NAME” has a wider variety of keywords than “LOCATION.” Referring back to FIG. 21, the ATTRIBUTE FIELD NAME text box 7023 shows “STORE NAME” selected in this way, as a result of a master table search performed with respect to the keyword specified in the SEARCH KEYWORD text box 7022.

The SEARCH RANGE list 7024 shows several data items of the incident table, which can be subjected to keyword search. In the example of FIG. 21, the “TITLE” and “DESCRIPTION” fields are selected as a search range. The user is also allowed to add “FINDINGS & CAUSES” and “ACTION & ANSWER” in the search range if desired.

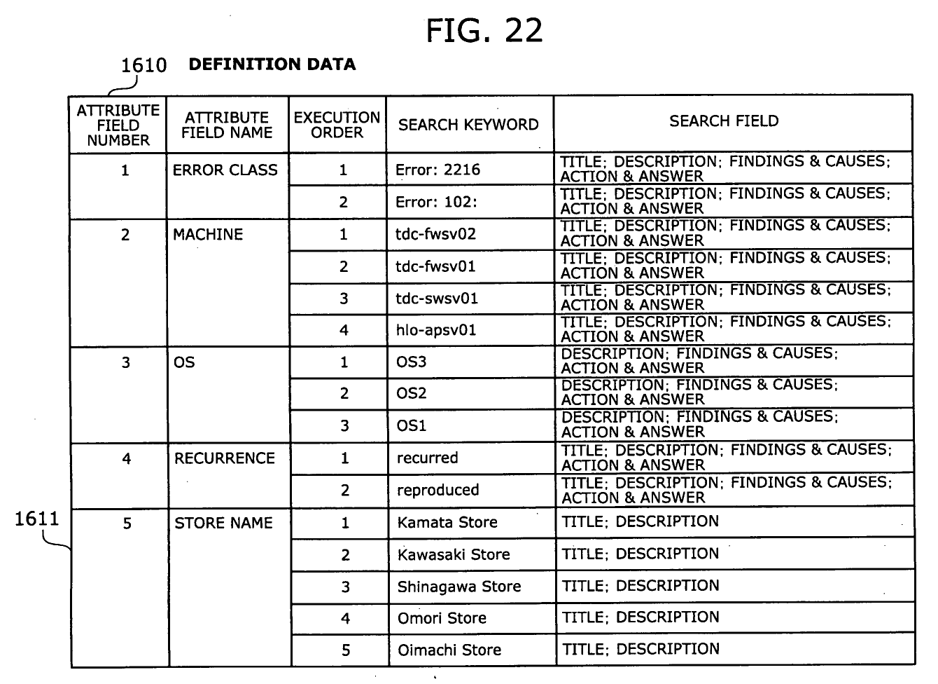

FIG. 22 summarizes the definition data produced by the above process of key attribute item definition. The produced definition data 1610 includes, among others, the following data fields: “ATTRIBUTE FIELD NAME,” “SEARCH KEYWORD,” and “SEARCH FIELD.” The storage unit 150 stores these elements of definition data 1610 in separate tables, i.e., in an analysis definition management table 153, a search keyword definition table 155, and a search field definition table 154. The entry of a keyword “Shinagawa Store” has invoked a key attribute item definition process, which results in a new piece of definition data with an attribute field number of “5” as shown in the ATTRIBUTE FIELD NUMBER field 1611. The ATTRIBUTE FIELD NAME field contains a key attribute item “STORE NAME” selected as being relevant to the specified keyword. This new definition data further includes a plurality of search keywords extracted from the key attribute item “STORE NAME” and their execution order and search field definitions. Specifically, those search keywords are: “Kamata Store,” “Kawasaki Store,” “Shinagawa Store,” “Omori Store,” and “Oimachi Store.” Each search keyword is accompanied by the search field definitions, “TITLE” and “DESCRIPTION,” selected in the SEARCH RANGE list 7024 of the key attribute item definition window 702.

Referring back to the key attribute item definition window 702 of FIG. 21, the user presses a SEARCH button 7025 to initiate a process of generating a key attribute item table. (The user may instead press a CANCEL button 7026 to exit from the key attribute item definition window 702 without creating anything.) The key attribute item table generator 130 searches the incident table 2100 according to what the definition data 1610 defines in its ATTRIBUTE FIELD NUMBER, EXECUTION ORDER, SEARCH KEYWORD, and SEARCH FIELD fields. For example, the first round of searching is performed with a search keyword “Error: 2216” corresponding to ATTRIBUTE FIELD NUMBER=1 and EXECUTION ORDER=1, scanning through the TITLE field 2102, DESCRIPTION field 2103, FINDINGS & CAUSES field 2104, and ACTION & ANSWER field 2105 of the incident table 2100. In the present example, the search keyword “Error: 2216” is found in the DESCRIPTION field 2103 of incident record “THH000154.” Accordingly, the key attribute item table generator 130 extracts this incident ID “THH000154” and puts it into the INCIDENT ID field 1561 of the key attribute item table 1560 (FIG. 14). The search keyword “Error: 2216” found in the above incident record is then entered to the ATTRIBUTE #1 field 1562 since its corresponding attribute field number is 1. When the scanning of all incident records is finished, the key attribute item table generator 130 then moves its focus to the next search keyword, i.e., “Error: 102:” corresponding to ATTRIBUTE FIELD NUMBER=1 and EXECUTION ORDER=2. The incident record search is repeated in this way, with each search keyword defined in the definition data 1610. The key attribute item table 1560 is gradually populated with the extracted incident IDs and found search keywords.

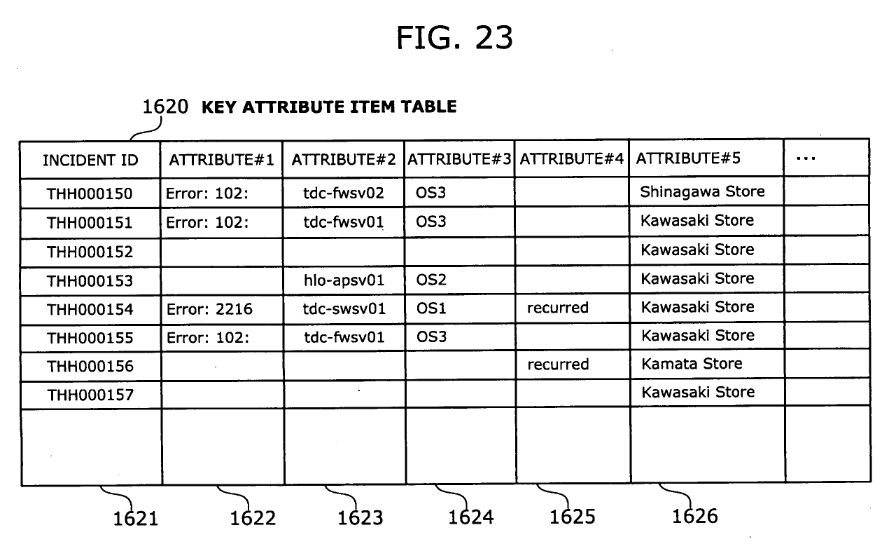

FIG. 23 shows an example of a key attribute item table produced by the above process of key attribute item table generation. The illustrated key attribute item table 1620 has been produced by searching the incident table 2100 by using search keywords listed in the definition data 1610.

Each record of the key attribute item table 1620 begins with an INCIDENT ID field 1621 that contains the incident ID of an incident record extracted because of its inclusion of search keywords. The INCIDENT ID field 1621 is followed by several ATTRIBUTE fields arranged in the order of their attribute field numbers. For example, the ATTRIBUTE #1 field 1622 contains search keywords “Error: 2216” and “Error: 102:” in the rows corresponding to incident records that match with either of the two search keyword. Those search keywords are registered in the key attribute item table 1620 as attribute values under a particular key attribute item. For example, the incident record “THH000150” contains “Error: 102:” as an attribute value of ATTRIBUTE #1.

Similar to the ATTRIBUTE #1 field 1622 discussed above, the subsequent four attribute fields 1623-1626, ATTRIBUTE #2 to ATTRIBUTE #5, contain search keywords found with respect to the attribute field numbers “2” to “5,” respectively. The incident record “THH000150” mentioned above contains three more search keywords: “tdc-fwsv02” under ATTRIBUTE #2, “OS3” under ATTRIBUTE #3, and “Shinagawa Store” under ATTRIBUTE #5. Such search keywords have been found in incident records and are thus registered in the key attribute item table 1620 as attribute values of each key attribute item.

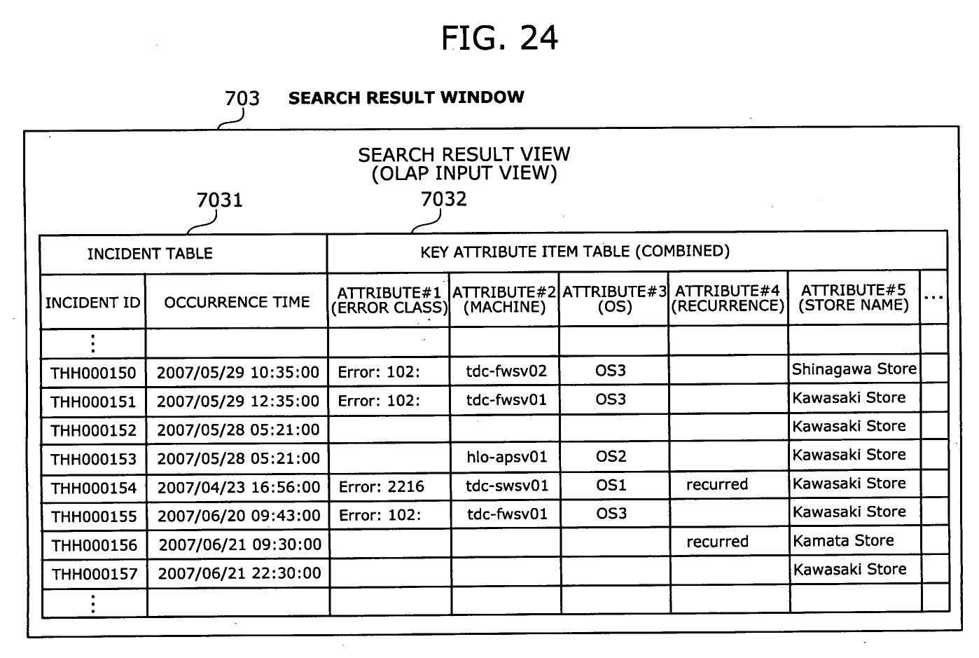

The search process initiated by the depression of SEARCH button 7025 in the key attribute item definition window 702 now outputs its outcomes based on the key attribute item table 1620. FIG. 24 shows an example of how the search result is displayed on a monitor screen. The illustrated search result window 703 is formed from an incident table 7031 indicating extracted incident records and a key attribute item table (combined) 7032 showing their attribute values.

The incident table 7031 shows a part of incident records that are extracted from the incident table 2100 based on the INCIDENT ID field 1621 of the key attribute item table 1620. Specifically, the incident table 7031 of FIG. 24 shows OCCURRENCE TIME field values of incident records, together with their respective incident IDs. The incident table 7031 is, however, not limited to this example, but may include other elements such as TITLE field. The key attribute item table (combined) 7032, on the other hand, gives attribute values corresponding to those in the key attribute item table 1620. Besides being the result of an incident table search requested in the key attribute item definition window 702, those incident records and attribute values displayed on the search result window 703 will also serve as input to the subsequent data analysis.

### Data Analysis

This section describes data analysis based on the foregoing key attribute item table 1620, assuming the use of OLAP aggregation (multidimensional analysis). The analysis process first looks into the error occurrence count of each store with OLAP techniques based on the key attribute item table 1620. Specifically, the analysis server 100 summarizes statistics of each type of errors occurred at each store, based on attribute #1 (ERROR CLASS) and attribute #5 (STORE NAME).

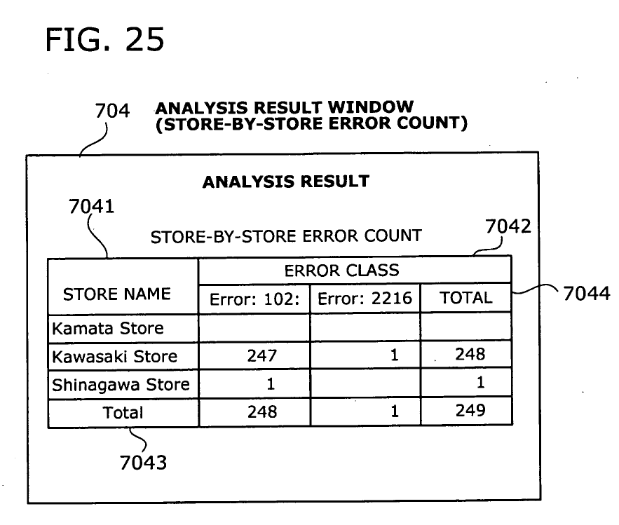

FIG. 25 gives an example of an analysis result window, specifically showing store-by-store error counts. The illustrated analysis result window (store-by-store error count) 704 shows analysis results in tabular form, with the rows representing STORE NAME 7041 and columns representing ERROR CLASS 7042. Also shown in this window are: total error count 7043 of each error class, and total error count 7044 of each store.

The above data may be subjected to a process of analyzing the tendency of error occurrence at each store. In the example of FIG. 25, Kawasaki Store appears to experience frequent errors classified as “ERROR: 102.” Accordingly the analysis investigates how the number of those errors varies with time, extracting incident records containing “ERROR: 102:” in attribute #1 (ERROR CLASS) and “Kawasaki Store” in attribute #5 (STORE NAME).

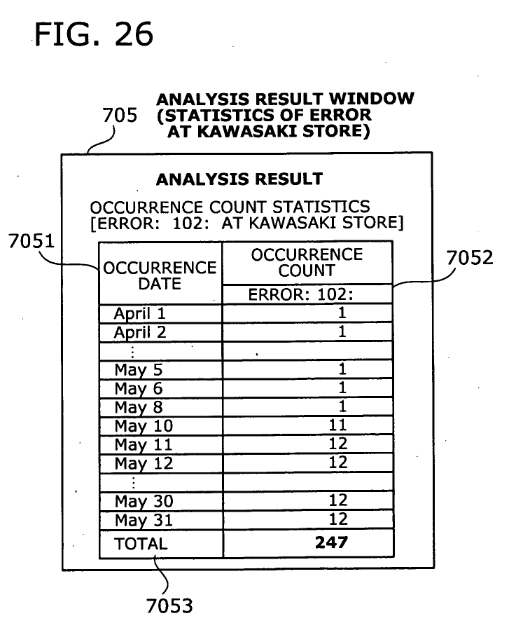

FIG. 26 gives an example of an analysis result window. This analysis result window 705 shows the statistics of errors “ERROR: 102:” occurred at Kawasaki Store in the form of OCCURRENCE COUNT 7052 versus OCCURRENCE DATE 7051. This table shows the daily number of errors with an error class of “ERROR: 102:” encountered during the period from April 1 to May 31.

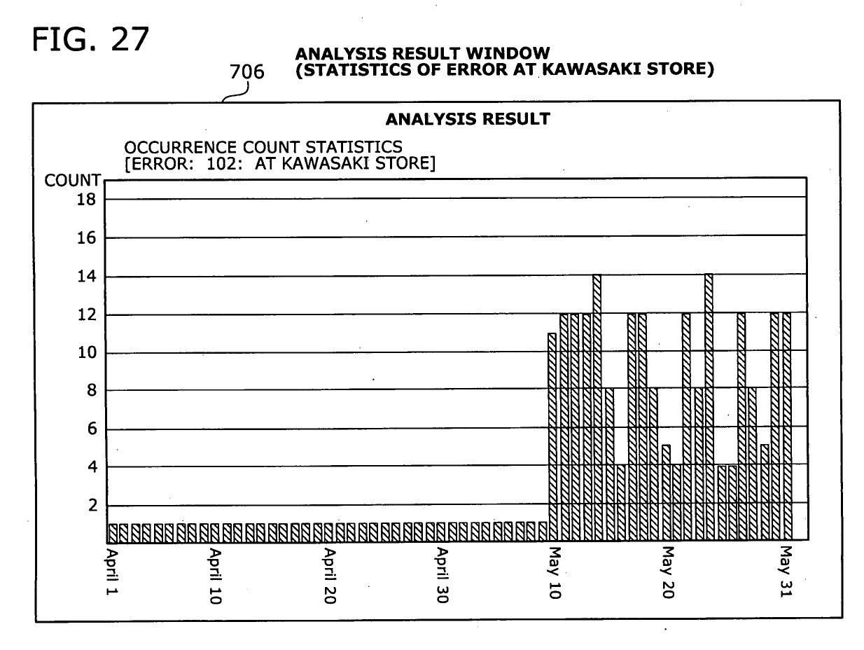

The analysis results may be presented in graph form, rather than in tabular form. FIG. 27 gives another example of an analysis result window, specifically showing the same statistics of errors occurred at Kawasaki Store. The illustrated analysis result window 706 is a bar chart representation of the content of FIG. 26, where the horizontal axis represents the date and the vertical axis represents the number of errors. Graphic representation of analysis results helps the user to find a tendency of error occurrence statistics. In the present example, the bar chart indicates a sharp increase of errors on and after May 10.

According to the above-described first embodiment, the proposed analysis server 100 permits the user to pick up a keyword from an incident record he/she is browsing on a monitor screen. This keyword suggests which data item the user wishes to analyze. The analysis server 100 dynamically determines key attribute items and search keywords according to the specified keyword and extracts incident records related to the keyword of interest. This extraction of incident records is based on a collection of search keywords that have been extracted from master tables as sharing the same attribute with the specified keyword. Accordingly, the resulting set of extracted incident records are likely to contain desired information completely. The analysis server 100 also creates a key attribute item table, together with the above data. This key attribute item table summarizes attribute values of incident records, which can be subjected immediately to data analysis.

### Second Embodiment

This section describes a second embodiment of the present invention. According to the second embodiment, the key attribute item definition manager 120 displays interim results of a process of defining a key attribute item, thereby allowing the user to participate in the process.

The overall process flow of the second embodiment is similar to that of the first embodiment discussed in FIGS. 15 to 18. The second embodiment, however, is different from the first embodiment in how it handles the case where a plurality of candidate attribute items are obtained with respect to a specified keyword. As discussed earlier in FIG. 17, the key attribute item definition process of the first embodiment checks whether there are two or more master tables and candidate attribute items (step S22) and, if so, it automatically selects a single master table and a single candidate attribute item based on a predetermined selection policy (step S23). The second embodiment modifies the step S23 such that the user will be prompted to choose a key attribute item.

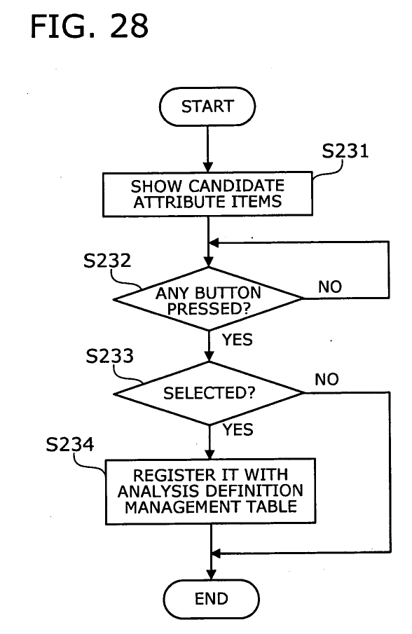

FIG. 28 is a flowchart of a key attribute item selection process according to the second embodiment. This process includes the following steps, which are to replace step S23 of FIG. 17.

(Step S231) The process displays a list of attribute item candidates (i.e., relevant columns of the extracted master tables). More specifically, the process now has two or more candidate attribute items which have been found relevant to the specified keyword. Accordingly, the process retrieves the name of each attribute item and every corresponding text string from the master tables. The retrieved attribute names and text strings are compiled into a list for viewing by the user. The user is then prompted to choose one of the listed attribute items as a key attribute item, together with its corresponding text strings listed as search keyword candidates.

(Step S232) The process waits for the user to press a button. The user may select a specific attribute item from among the candidate attribute items listed on the monitor screen. Alternatively, the user may select a CANCEL button. The process waits for either action to happen.

(Step S233) The process determines whether the user has selected an attribute item. If so, the process advances to step S234. If, instead, a CANCEL button is selected, the process stops waiting and terminates itself.

(Step S234) The process registers the user-selected attribute item as a key attribute item. Specifically, the process enters its attribute field name to the analysis definition management table 1530, together with a new attribute field number.

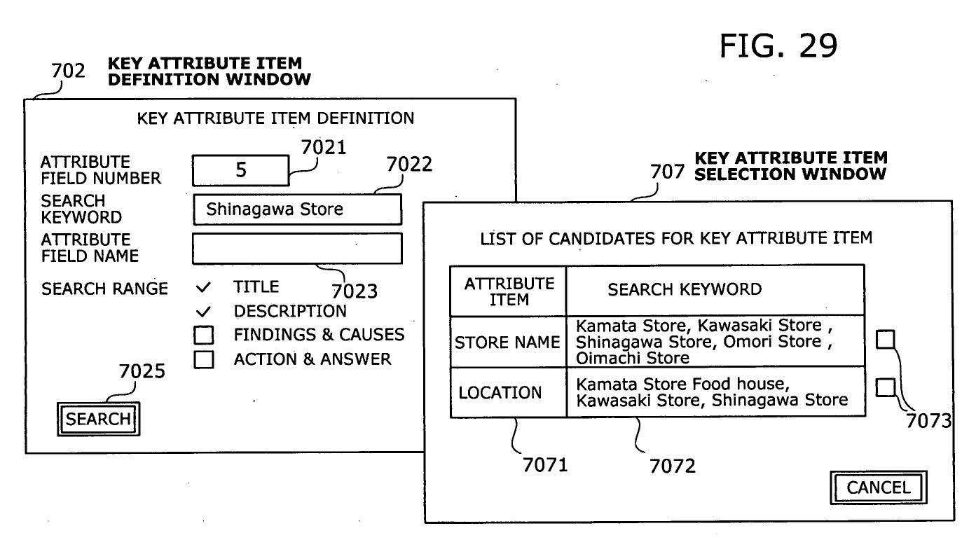

FIG. 29 shows an example window including a list of candidates for key attribute item. The left half of FIG. 29 shows a key attribute item definition window 702, which is identical to what is shown in FIG. 21. According to the first embodiment discussed in FIG. 21, the analysis server 100 automatically selects a key attribute item and displays its corresponding attribute field name in the ATTRIBUTE FIELD NAME text box 7023 upon entry of “Shinagawa Store” to the SEARCH KEYWORD text box 7022. According to the second embodiment, on the other hand, the same keyword entry invokes the processing steps described in FIG. 28, thus producing a key attribute item selection window 707.

The key attribute item selection window 707 provides an ATTRIBUTE FIELD NAME list 7071 enumerating candidate attribute items that are found, along with their associated search keyword candidates 7072, for the purpose of viewing by the user. Placed beside those candidates are check boxes 7073 for the purpose of selecting a particular candidate. When the user selects either one of those check boxes 7073, the corresponding attribute item name is copied to the ATTRIBUTE FIELD NAME text box 7023.

Through the above-described process, the second embodiment provides a key attribute item selection window 707 in which the user can select a most appropriate candidate for the key attribute item from among those that have been extracted from master tables according to a specified keyword. The key attribute item selection window 707 may also be designed to allow the user to specify search keywords out of a list of possible search keywords. In this case, the user-specified set of search keywords are entered to the search keyword definition table 1550.

### Third Embodiment

This section describes a third embodiment of the present invention. In the third embodiment, the key attribute item definition manager 120 helps the user to define search keywords manually. The overall process flow in the third embodiment is similar to that of the first embodiment discussed in FIGS. 15 to 18, except for the fact that the selection of search keywords depends on user commands. That is, the third embodiment modifies the process of key attribute item definition shown in FIG. 17. The following section will describe how the key attribute item definition manager 120 supports manual addition of a new search keyword to the existing set of search keywords. Addition of a keyword proceeds in accordance with the commands that the user gives in response to presentation of candidates for search keywords. During the course of this process, the user interacts with the key attribute item definition manager 120 through several windows displayed on his/her terminal screen. The following section describes each such window before explaining processing steps.

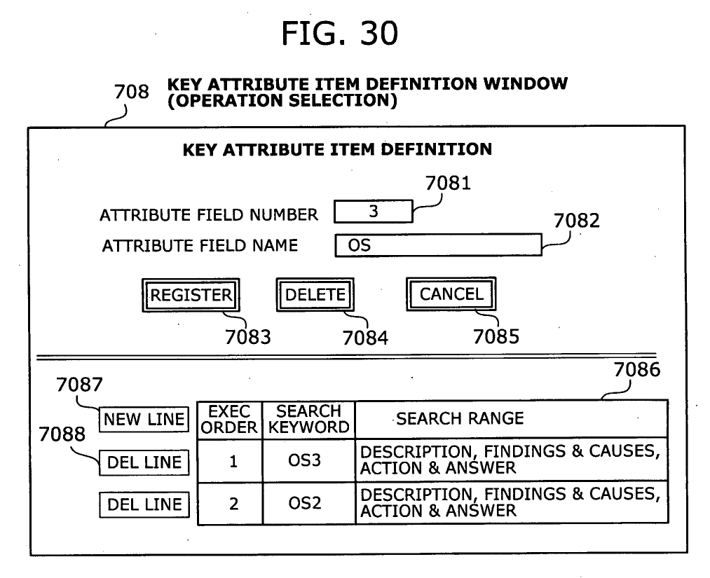

FIG. 30 shows a first example of a key attribute item definition window, in which the user selects which operation to perform. The illustrated key attribute item definition window (operation selection) 708 appears on a monitor screen in the first place when a specific attribute field number is entered.

The key attribute item definition window (operation selection) 708 offers an ATTRIBUTE FIELD NUMBER text box 7081 and an ATTRIBUTE FIELD NAME text box 7082 to show a specified attribute field number and its corresponding attribute field name, respectively. The latter information is obtained by performing a search using the attribute field number as a search key.

The key attribute item definition window (operation selection) 708 further shows some pieces of definition data 7086 in a table. In the present example, the definition data 7086 gives search keywords corresponding to the attribute field number “3,” together with their respective search ranges, arranged in accordance with the execution order. Those search keywords have been retrieved from the search keyword definition table 1550 of FIG. 13. More specifically, they derive from the records corresponding to the attribute field number “3.” Similarly, the search ranges shown in the definition data 7086 have been retrieved from the search field definition table 1540 of FIG. 12 as being relevant to the attribute field number “3.” FIG. 30 assumes that two search keywords have been defined (and hence the execution order “2”). At the very early stage where no definition data is present, nothing appears in the ATTRIBUTE FIELD NAME text box 7082 or DEFINITION DATA 7086.

The user controls the process of registering key attribute items by operating a REGISTER button 7083, a DELETE button 7084, and a CANCEL button 7085. Further provided in the same window are a NEW LINE button 7087, and two DEL LINE (or DELETE LINE) buttons 7088 placed beside each record of the definition data 7086. By pressing the REGISTER button 7083, the user can send the current contents of the ATTRIBUTE FIELD NUMBER text box 7081 and ATTRIBUTE FIELD NAME text box 7082 to ATTRIBUTE FIELD NUMBER field 1531 and ATTRIBUTE FIELD NAME field 1532 of the analysis definition management table 1530. By pressing the DELETE button 7084, the user can remove the existing definition data corresponding to the ATTRIBUTE FIELD NUMBER text box 7081. By pressing the NEW LINE button 7087, the user can initiate a master table search by using the search keywords registered in the definition data. Out of the extracted master table, new search keyword candidates are extracted as having the same attribute as the existing search keywords. By pressing a DEL LINE button 7088, the user can delete a corresponding search keyword.

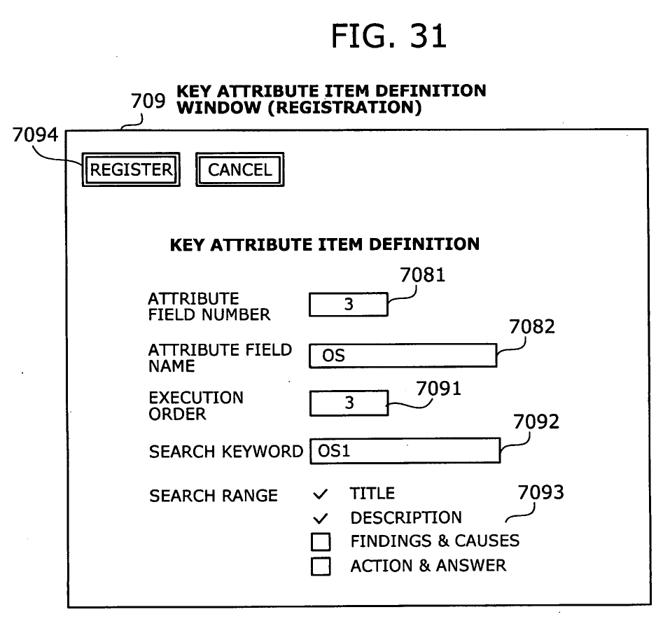

Suppose now that the user has pressed the NEW LINE button 7087. This operation enables registration mode, in which the user is allowed to add a search keyword. Referring to FIG. 31, the following will describe a window for registering search keyword candidates. FIG. 31 shows a second example of a key attribute item definition window, in which the user adds a new line of search keyword definition. The illustrated key attribute item definition window (registration) 709 offers a candidate for search keyword that has been extracted based on the attribute field number and existing search keywords. The NEW LINE button 7087 shown in FIG. 30, when pressed, initiates a process of adding a new line of search keyword definition. Specifically, the EXECUTION ORDER text box 7091 gives the smallest unused number (e.g., “3”) at the moment, while the SEARCH KEYWORD text box 7092 accommodates a new search keyword. In the example of FIG. 31, “OS1” is entered as a new search keyword. The SEARCH RANGE list 7093 shows an initial setup for the search range definition. The user may press a REGISTER button 7094 in this context. If this is the case, the key attribute item definition manager 120 registers the values of SEARCH KEYWORD and SEARCH RANGE with the search keyword definition table 1550 and search field definition table 1540 as their new entry identified by an attribute field number of 3 and an execution order number of 3.

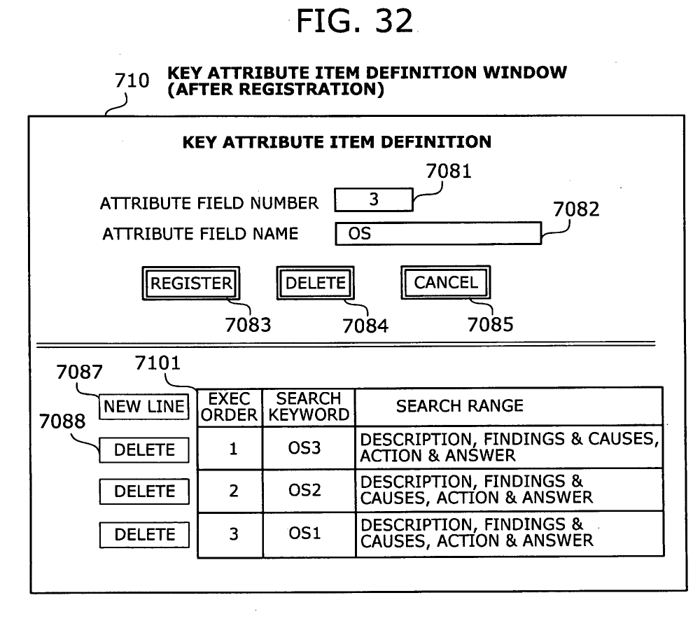

FIG. 32 shows a third example of a key attribute item definition window, which includes a newly registered search keyword. Specifically, FIG. 32 shows the case where a search keyword “OS1” has just been registered through the key attribute item definition window (registration) 709 shown in FIG. 31. The key attribute item definition window (after registration) 710 now has an updated DEFINITION DATA section 7101 with a new search keyword “OS1” and its corresponding search range definition in the bottommost record identified by an EXEC ORDER value of “3.”

In this key attribute item definition window 710, the user may select the NEW LINE button 7087 again to add yet another search keyword by following the same procedure as above.

Through the above-described process, the third embodiment enables the user to register a new search keyword definition by consulting a search keyword candidate extracted based on the existing search keywords. This feature of the third embodiment assists the user to set better search keywords for wider coverage of search.

### Computer-Readable Storage Medium

The foregoing processing mechanisms are actually implemented on a computer system, the instructions being encoded and provided in the form of computer programs. A computer system executes such programs to provide the intended functions of the present invention. The programs are stored in a computer-readable medium for the purpose of storage and distribution. Suitable computer-readable storage media include magnetic storage devices, optical discs, magneto-optical storage media, semiconductor memory devices, and other tangible storage media. Magnetic storage devices include hard disk drives (HDD), flexible disks (FD), and magnetic tapes, for example. Optical discs include digital versatile discs (DVD), DVD-RAM, compact disc read-only memory (CD-ROM), CD-Recordable (CD-R), and CD-Rewritable (CD-RW), for example. Magneto-optical storage media include magneto-optical discs (MO), for example.

Portable storage media, such as DVD and CD-ROM, are suitable for distribution of program products. Network-based distribution of software programs may also be possible, in which case several master program files are made available on a server computer for downloading to other computers via a network.

A user computer stores necessary software components in its local storage unit, which have previously been installed from a portable storage media or downloaded from a server computer. The computer executes the programs read out of the local storage unit, thereby performing the programmed functions. As an alternative way of program execution, the computer may execute programs, reading out program codes directly from a portable storage medium. Another alternative method is that the user computer dynamically downloads programs from a server computer when they are demanded and executes them upon delivery.

### CONCLUSION

To summarize the above description, the present invention provides a computer program and method for determining key attribute items for use in data analysis, as well as a data analyzing apparatus implementing the same. Upon entry of a specified keyword, the method retrieves master tables containing the specified keyword and extracts therefrom key attribute items and search keywords. By using those search keywords, the method extracts relevant incident records for data analysis. The proposed method eliminates the need for users to assign classification code or other additional information to incident records when registering them, or to define each every keyword for an incident record search, thus alleviating their workload. The user is allowed to select an appropriate keyword depending on his/her needs. The proposed method determines key attribute items and search keywords dynamically in accordance with the user demand and operating environment at that time.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable storage medium encoded with a program for determining key attribute items for analysis of document records, the program, when executed on a computer, causing the computer to act as an apparatus comprising:
a master table search processor that extracts a master table containing a text string that matches with a specified keyword and identifies an attribute item of the master table under which the match is found;
a search keyword extractor that extracts text strings registered under the identified attribute item of the extracted master table for use as search keywords, while selecting the identified attribute item as a key attribute item;
an attribute item information generator that searches stored document records to extract those containing the search keywords and produces attribute item information associating each of the extracted document records with the search keywords found therein and key attribute items corresponding thereto; and
an attribute item information storage unit that stores the produced attribute item information.

2. The computer-readable storage medium according to claim 1, wherein:
the document records contain information in text data form; and
the master tables store text strings itemized by attributes thereof, so that a class of text strings sharing a particular attribute are stored under an attribute item representing that attribute.

3. The computer-readable storage medium according to claim 1, the program causing the computer to act further as:
an incident manager that displays details of an document record specified from among the stored document records and permits a text string in the specified document record to be selected as the specified keyword for use by the master table search processor.

4. The computer-readable storage medium according to claim 1, wherein:
the master table search processor identifies a plurality of attribute items corresponding to the specified keyword; and
the search keyword extractor evaluates the identified attribute items as candidates for the key attribute item by comparing search keywords extracted under each candidate, so that one of the candidates is selected as the key attribute item based on a predefined selection policy.

5. The computer-readable storage medium according to claim 4, wherein the search keyword extractor calculates how many different search keywords are found under each candidate and selects a candidate with the largest number of different search keywords as the key attribute item.

6. The computer-readable storage medium according to claim 3, wherein the search keyword extractor calculates how many of the search keywords found under each candidate are identical with the specified keyword and selects a candidate with the smallest number of matches as the key attribute item.

7. The computer-readable storage medium according to claim 1, wherein:
the document records comprises a plurality of data items stored in text data form; and
the search keyword extractor determines which of the data items to search, according to properties of the key attribute item.

8. The computer-readable storage medium according to claim 1, wherein:
the attribute item information generator produces, as the attribute item information, a key attribute item table organized by rows representing different document records and columns representing different key attribute items; and
the key attribute item table contains a search keyword found under a key attribute item of an document record at a row/column position corresponding to that document record and that key attribute item.

9. The computer-readable storage medium according to claim 1, wherein:
the master tables are managed by business servers that produce document records; and
the master table search processor obtains a latest set of master tables from the business servers before beginning a search, based on a master table list that associates an identifier of each master table with the application server storing that master table.

10. The computer-readable storage medium according to claim 1, wherein the document records include incident records.

11. A method for determining key attribute items for analysis of document records, the method comprising:
extracting a master table containing a text string that matches with a specified keyword and identifying an attribute item of the master table under which the match is found;
selecting the identified attribute item as a key attribute item;
extracting text strings registered under the identified attribute item of the extracted master table for use as search keywords;
searching stored document records to extract those containing the search keywords;
producing attribute item information associating each of the extracted document records with the search keywords found therein and key attribute items corresponding thereto; and
storing the produced attribute item information in a storage device.

12. A data analyzing apparatus for determining key attribute items for analysis of document records and analyzing the document records based on the determined key attribute items, the data analyzing apparatus comprising:
a master table search processor that extracts a master table containing a text string that matches with a specified keyword and identifies an attribute item of the master table under which the match is found;
a search keyword extractor that extracts text strings registered under the identified attribute item of the extracted master table for use as search keywords, while selecting the identified attribute item as a key attribute item;
an attribute item information generator that searches stored document records to extract those containing the search keywords and produces attribute item information associating each of the extracted document records with the search keywords found therein and key attribute items corresponding thereto;
an attribute item information storage unit that stores the produced attribute item information; and
an analyzer that performs analysis of the document records by using the attribute item information produced by the attribute item information generator.
